(19) United States
(12) Patent Application Publication
(10) Pub. No.: US 2012/0185782 A1
(43) Pub. Date: Jul. 19, 2012

(54) METHOD AND SYSTEM FOR COLLECTION AND MANAGEMENT OF REMOTE OBSERVATIONAL DATA FOR BUSINESS

(76) Inventor: Phillip Anthony Storage, Mason, OH (US)

(21) Appl. No.: 13/435,280

(22) Filed: Mar. 30, 2012

Related U.S. Application Data
(63) Continuation-in-part of application No. 12/889,563, filed on Sep. 24, 2010.
(60) Provisional application No. 61/246,003, filed on Sep. 25, 2009.

(51) Int. Cl. G06F 3/048; G06F 15/16

(52) U.S. Cl. 715/757

(57) ABSTRACT

Wholesalers, manufacturers, retailers and other entities can use a network gateway as a common point of access to information regarding the presentation of their products to consumers. Such a gateway could be used by representatives for uploading information gathered at retail locations using specially designed mobile applications which would include functionality for facilitating later search and retrieval of the information, such as by tagging.

### CROSS REFERENCE TO RELATED APPLICATIONS

This application is a Continuation-In-Part (CIP) of U.S. patent application Ser. No. 12/889,563, entitled “Method and System for Collection and Management of Remote Observational Data for Businesses,” which was filed Sep. 24, 2010, which claims priority from U.S. Provisional patent application 61/246,003, filed on Sep. 25, 2009, entitled “A Method and System for Collection and Management of Image-Based Product Display Data.” The disclosures of which are both hereby incorporated by reference in their entirety.

### BACKGROUND

Historically, businesses have had no satisfactory way of gathering and maintaining data about the conditions of remote locations. For example, consider the case of consumer products, consumer goods, and consumer packaged goods manufacturers. These entities have used a variety of approaches to gather information regarding the manner in which their products are presented to consumers. These approaches include relying on syndicated or scanned information provided by market research firms such as Nielsen or IRI, and performing ad hoc data gathering through their sales teams or third parties, such as food brokers. Unfortunately, there are numerous problems with these existing approaches. Purchasing scanned or syndicated information does not allow the purchaser (e.g., manufacturer, wholesaler or retailer) to see how a particular product is actually displayed in a store. Additionally, the results of supplementing scanned or syndicated information by having a sales representative or third party take a picture and email it back to the manufacturer are not satisfactory. Relying on information which is emailed (or otherwise sent) directly to the manufacturer slows communication, as it places a burden on whoever receives the image of distributing it to other individuals who may need it. Furthermore, emailed images can easily become inaccessible, as emails are often deleted (sometimes inadvertently or by automatic operation of an email system) or simply lost. Also, and perhaps surprisingly given their poor results, existing approaches are expensive, imposing costs in terms of money paid for syndicated data or food brokers, as well as resources and administrative overhead needed to store and manage information obtained through ad hoc data collection.

Accordingly, there has been a long-felt but unmet need for improved technology for providing information regarding the manner in which consumer products, consumer goods and consumer packaged goods are presented to consumers. Additionally, these difficulties are by no means unique to consumer goods, consumer products and consumer packaged goods businesses. As a result, the long-felt but unmet need extends beyond consumer products, consumer goods and consumer packaged goods, and similarly afflicts other types of companies which are responsible for, or have their business affected by conditions at remote locations.

### SUMMARY

The technology disclosed herein can be implemented in a variety of manners, including establishing a gateway on a server which would allow employees and representatives of a manufacturer, wholesaler or retailer to have a common point of access to facilitate communicating, commenting, mining, and analyzing data regarding the manner in which their products are presented to consumers. Various aspects of this disclosure can be embodied in novel methods, machines, and articles of manufacture which address existing needs in the art. Additionally, infrastructure and approaches such as described herein can be used to provide support for new methods, machines and articles of manufacture which are either impossible or impractical based on current practices.

### BRIEF DESCRIPTION OF THE DRAWINGS

The drawings and detailed description which follow are intended to be merely illustrative and are not intended to limit the scope of the invention as contemplated by the inventor.

FIGS. 1a-1f depict how software utilized to implement aspects of the disclosed technology could be organized.

FIG. 2 depicts functions which could take place for a mobile application to interact with a gateway to access a server.

FIGS. 3a-3d depict activities which might be performed using a mobile device.

FIG. 4 depicts how different users, having different roles, can interact with a web application to access, upload, comment on, edit or otherwise use media in the system.

FIG. 5 depicts a high level architecture which could be used in the collection and management of media elements.

FIGS. 6a-6k depict interfaces that could be used to modify data in a database.

FIG. 7 depicts an organization which could be used for a database.

FIGS. 8a-8e depict interfaces which could be presented on a mobile device.

FIGS. 9a-9d depict interfaces which can be used to access or interact with data which has been uploaded to a database.

FIG. 10 depicts an interface which can allow a user to access compliance data through a system tray icon.

FIG. 11 depicts a non-limiting example embodiment of a visual analytics interface which may be presented to a user.

FIG. 12 depicts virtual conference room environments that allow for the exchange of information between multiple users in accordance with one non-limiting embodiment.

FIG. 13A-13C depict various displays of a user interface in accordance with one non-limiting embodiment.

### DETAILED DESCRIPTION

For the purpose of explaining the inventor's technology, this disclosure begins by describing certain component combinations, interactions and processes which can be used in the collection and management of media elements. This initial description focuses on the figures, which are set forth using commonly understood formats, such as the unified modeling language. This is followed by a discussion of particular and additional processes, applications, uses, and variations for the inventor's technology.

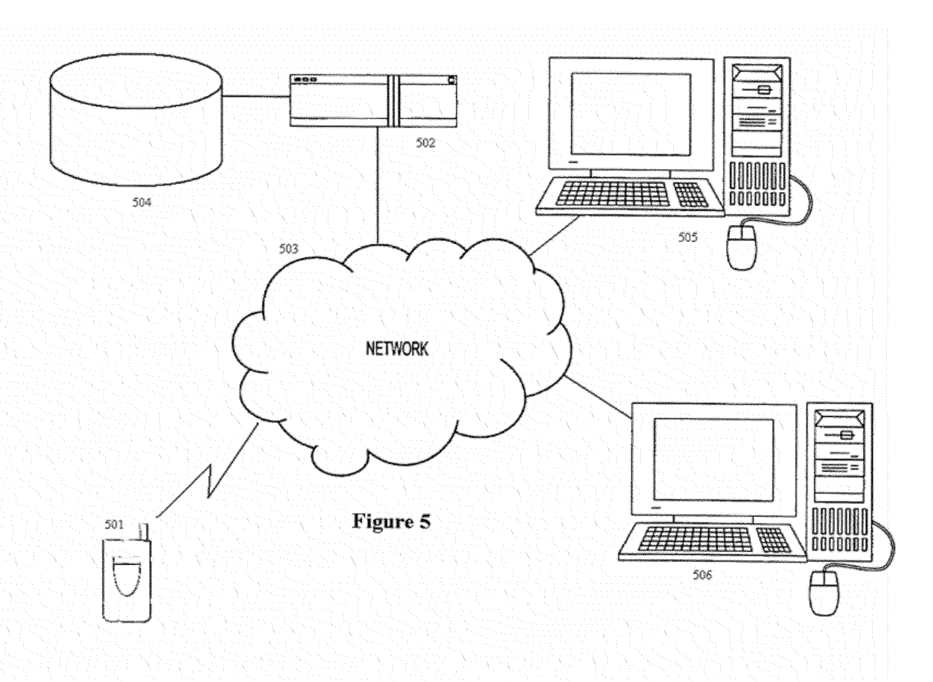

Turning now to FIG. 5, that figure depicts a high level architecture which could be used in the collection and management of media elements. In the architecture of FIG. 5, image-based display data (e.g., a picture or a video, herein referred to as a “media element”) could actually be captured using a mobile device (e.g., a smartphone) [501] which was carried by a representative of a manufacturer to various remote locations (e.g., stores). That mobile device [501] could be equipped with a specially designed mobile application which would facilitate the capture and management of data, for example, by providing tags which could function as metadata describing the data captured by the mobile device [501]. As shown in the architecture of FIG. 5, the mobile device [501] could be in wireless communication with a server computer [502] via a network [503], and the server computer [502] could itself be in communication with a database [504]. There could also be one or more end user computers [505][506] which could access the server computer [502] over the network [503] to view and comment on the information uploaded to the database [504].

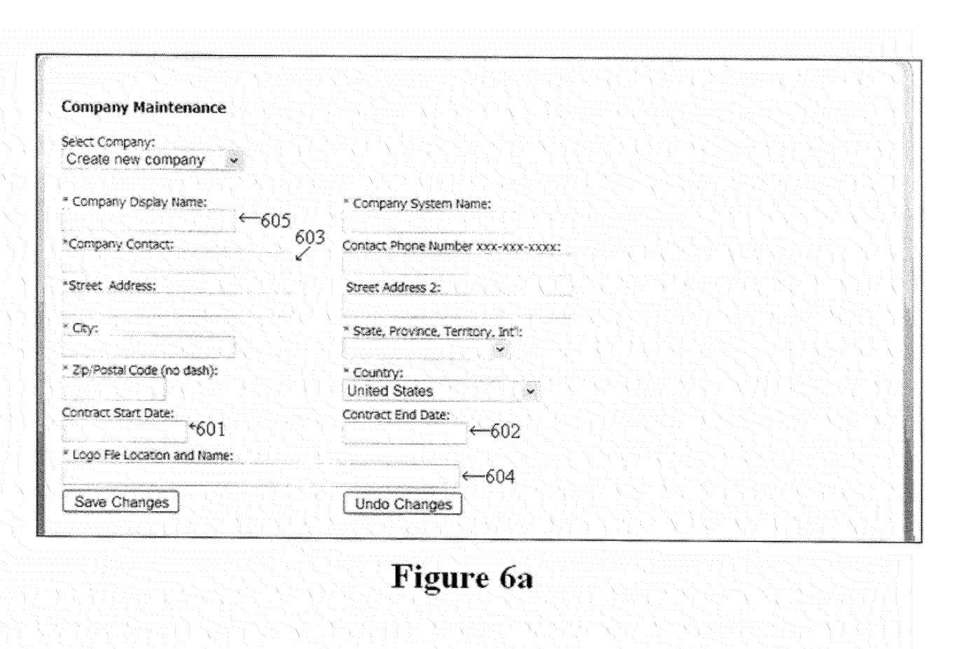

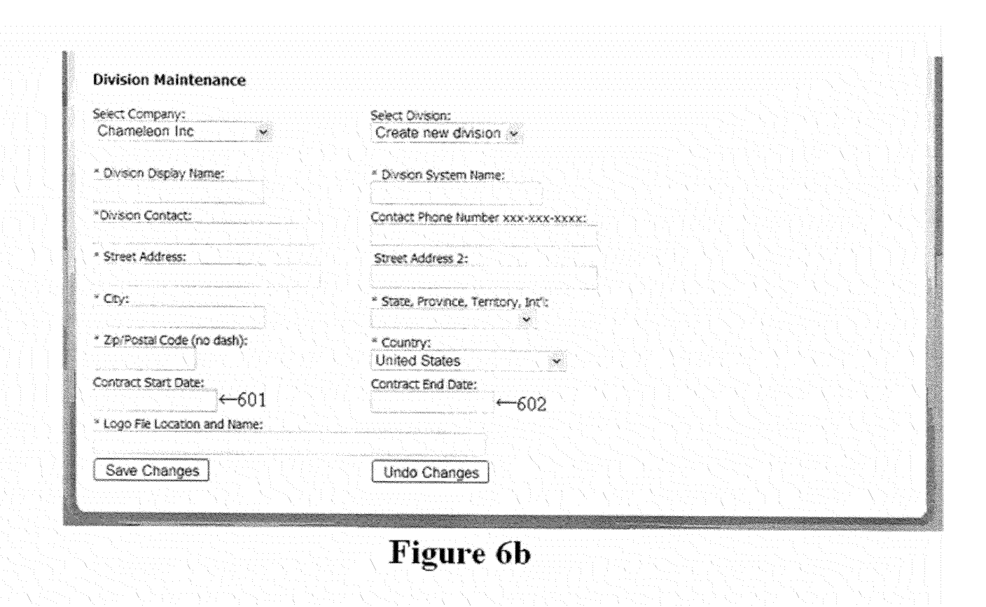

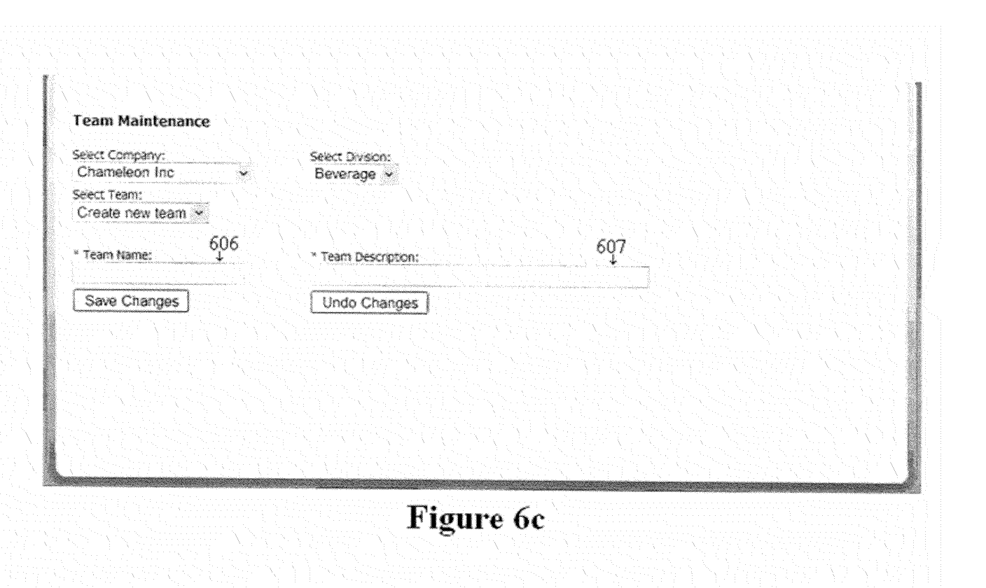

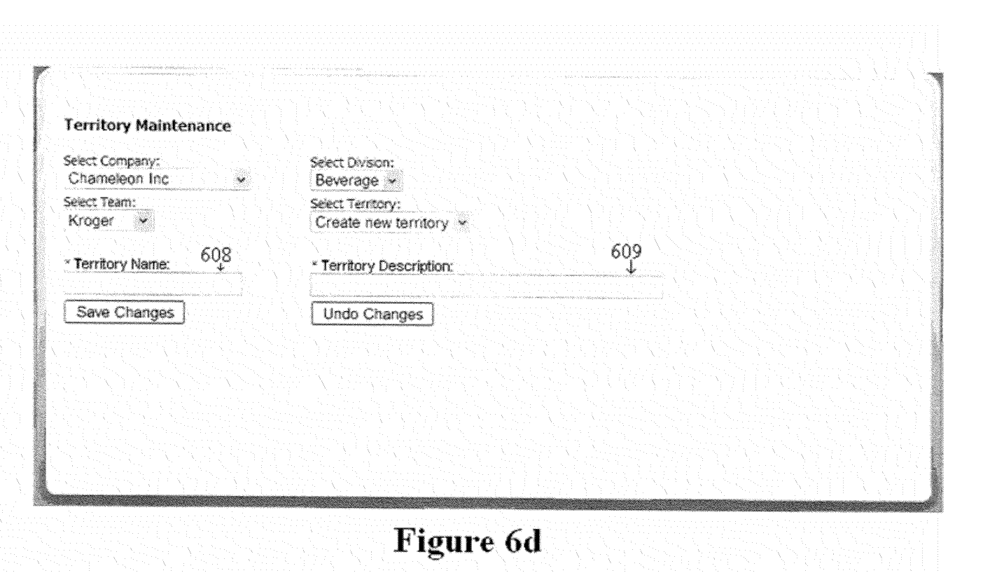

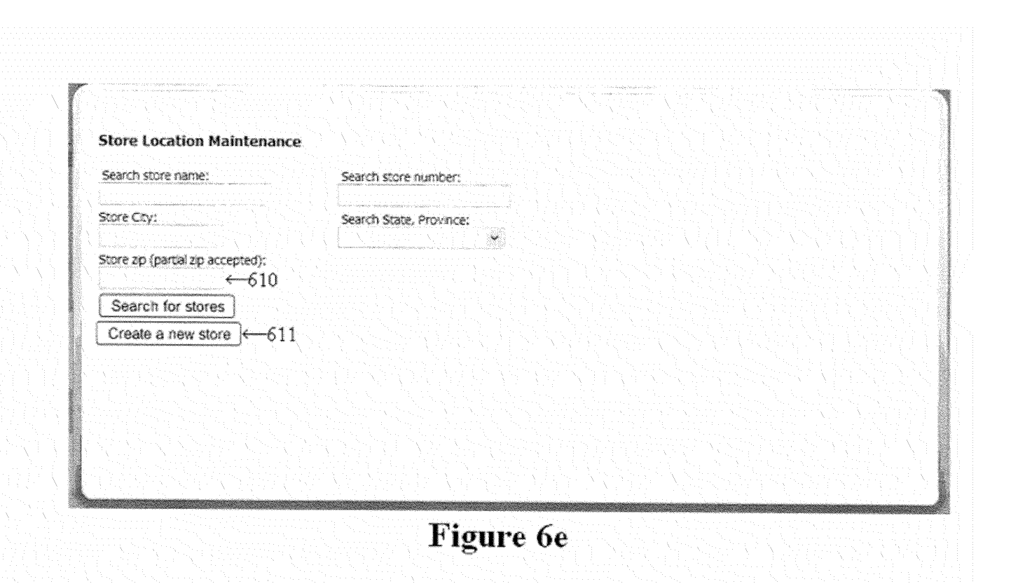

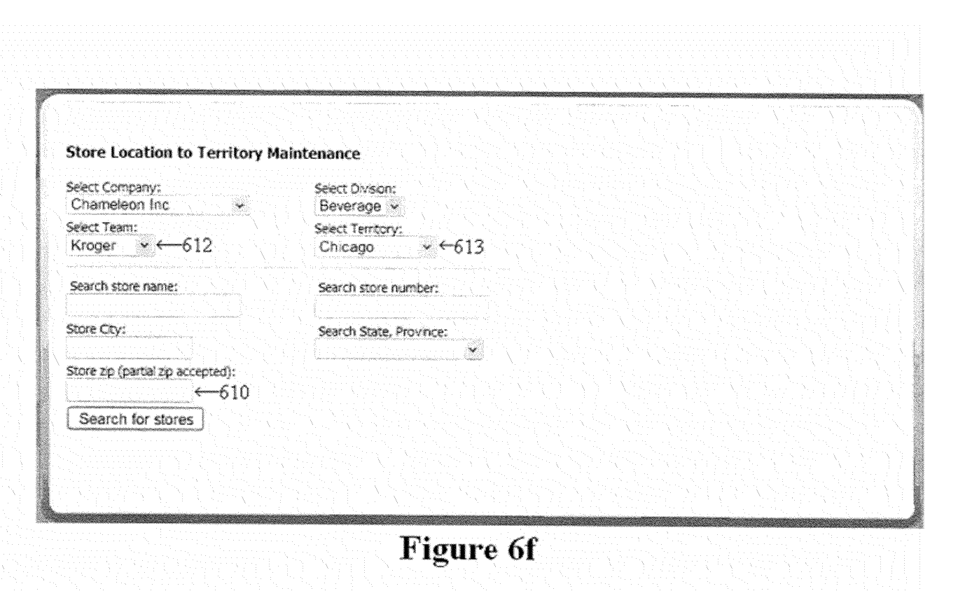

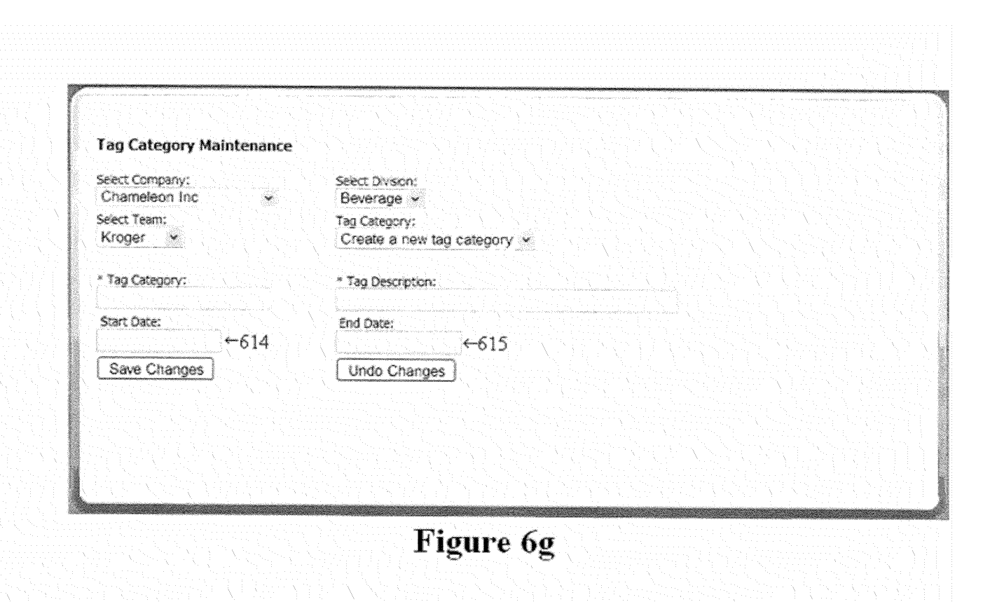

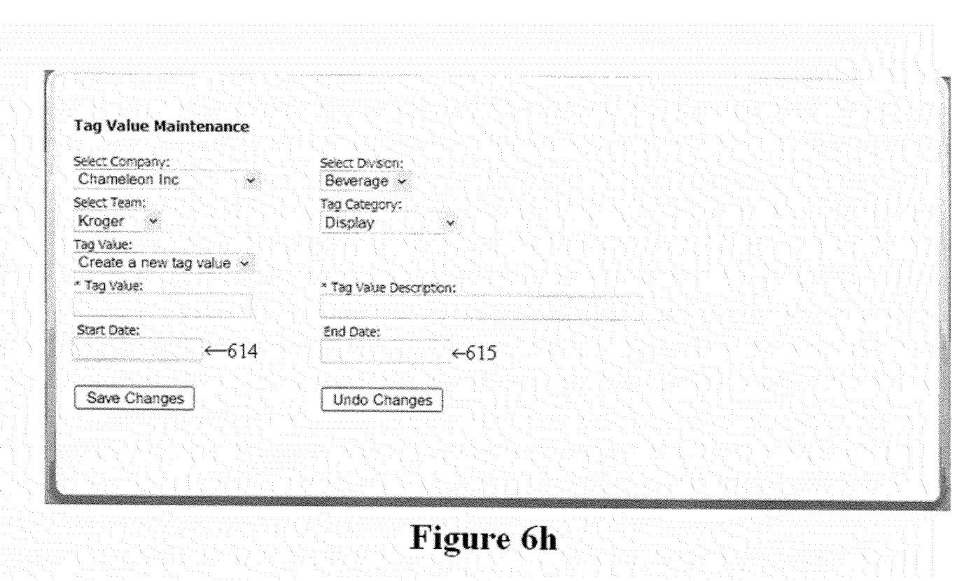

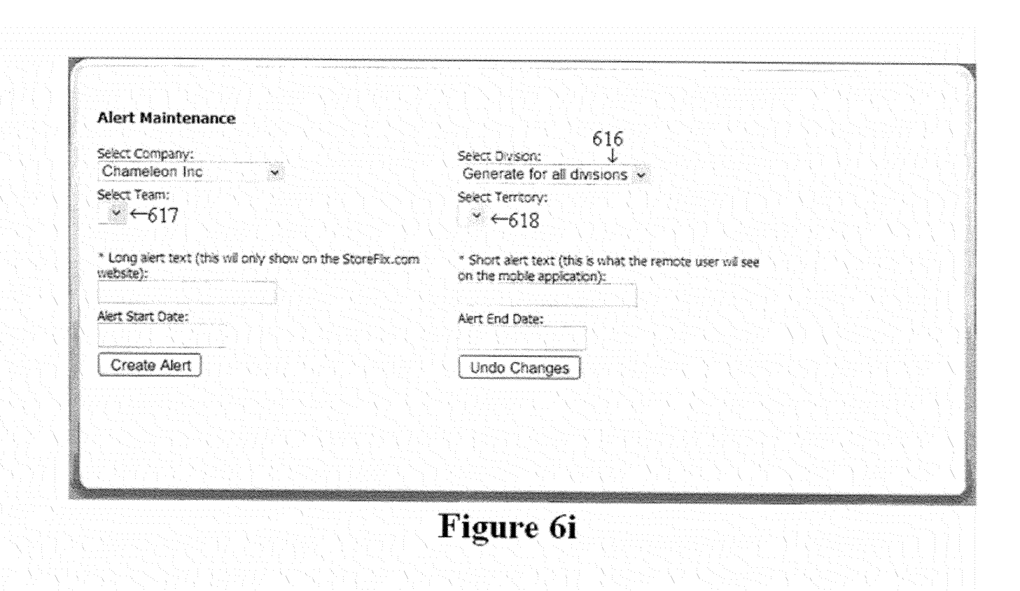

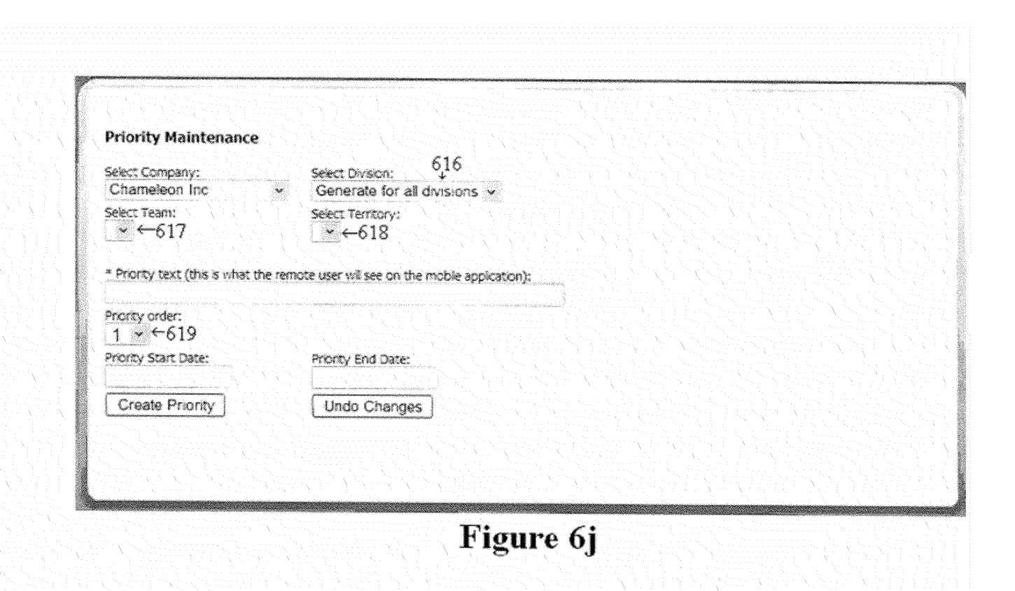

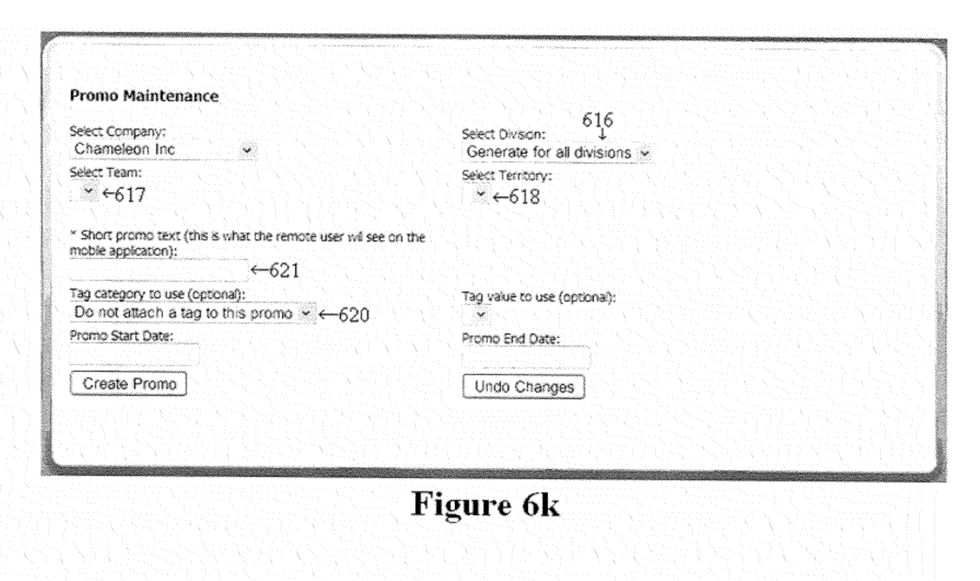

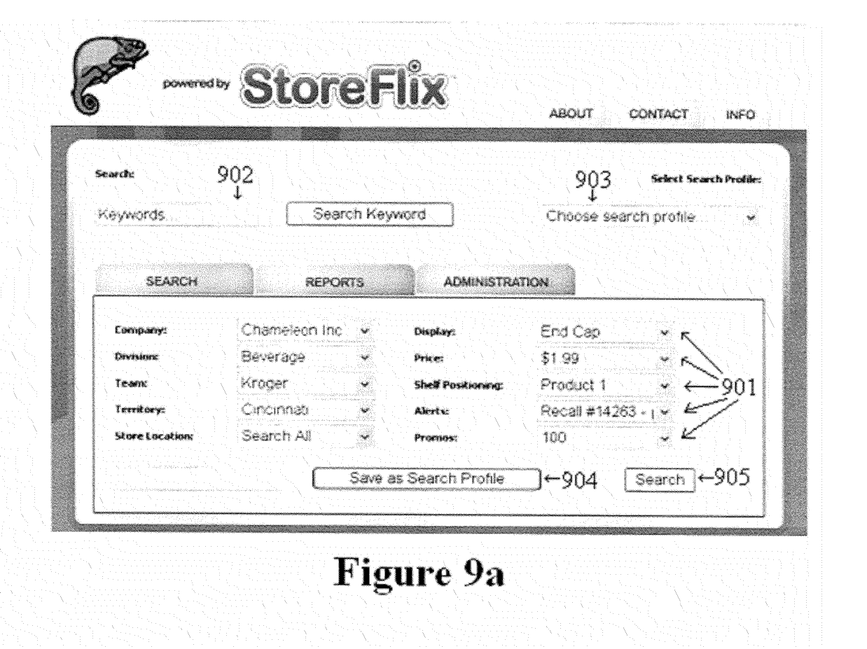

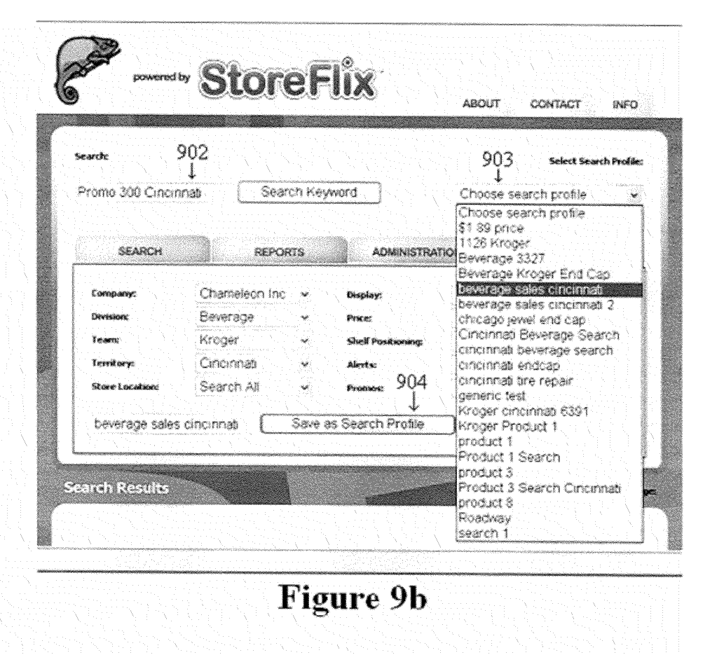

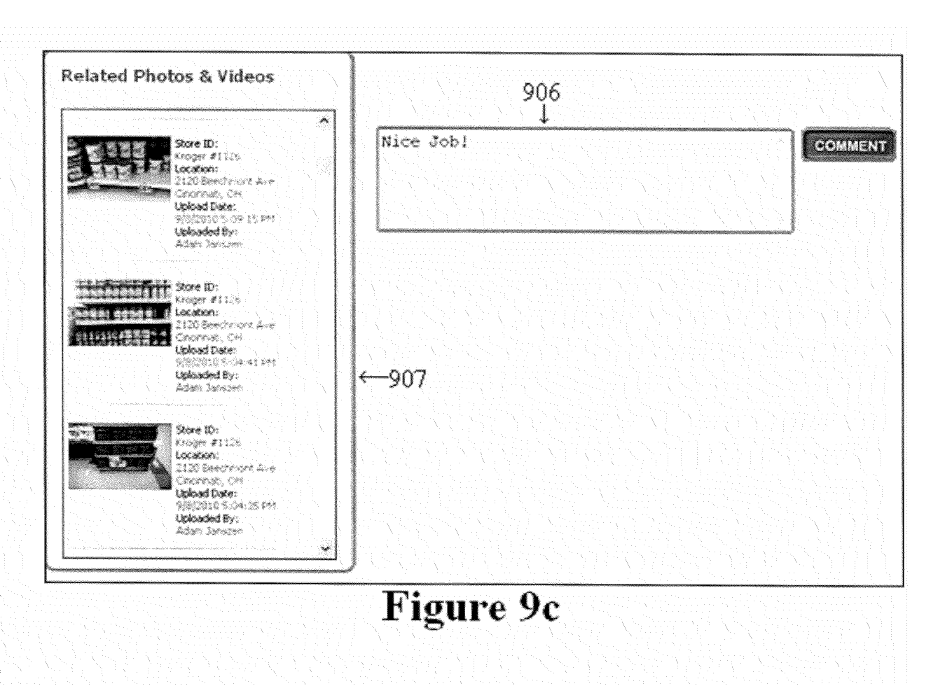

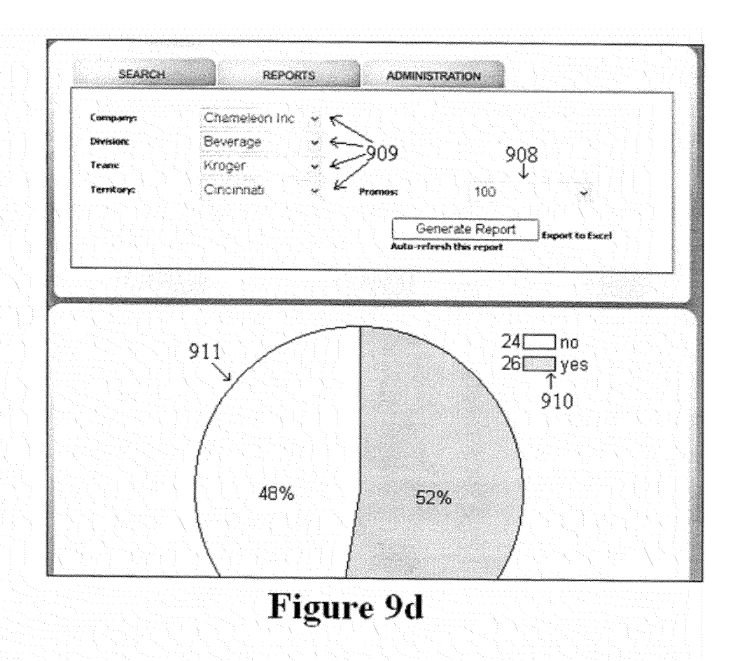

Turning now to FIGS. 6a-6b, those figures illustrate interfaces which could be used to set up a business (and/or organizational units of the same) to access functionality such as could be provided by a server [502] illustrated in FIG. 5. In FIG. 6a, the depicted interface includes fields for entering customer information about the business, such as fields for when the business's contract begins [601], when it ends [602], and the contact for the business [603]. Additionally, FIG. 6a includes fields for entering information which can be used to automatically create a custom web portal for the business such as a field for a logo to be displayed in the business' custom web portal [604], and a field for specifying the display name which would be included in the portal [605]. Such a custom web portal could be generated by inserting the logo and display name into a web page template stored in the database [504] when a user associated with the company logs into a main page (e.g., a gateway provided by the server [502]). Once logged into the custom web portal, the user could use it to access searching and reporting functionality as discussed in infra, in the context of FIGS. 9a-9d, and/or administrative functionality such as described in the context of FIGS. 6a-6k.

FIG. 6b illustrates that similar interfaces can be provided for various levels of organization for the company (e.g., divisions). This can be beneficial in cases where a company might want to have multiple custom portals provided for different divisions or other organizational units. Similarly, when a company might want to maintain different contracts with the provider of the server computer [502], interfaces such as shown in FIG. 6b can be used to reflect and enable such arrangements. This same approach can be used for other organizational levels as well, depending on the needs and structure of a particular company.

Once the company (and/or other organizational units as appropriate) has been defined, an administrator could utilize interfaces such as shown FIGS. 6c-6f to set up data which would correlate media elements captured on the mobile devices [501] with the business entity's field operation. For example, in the case of a consumer packaged goods company, the interface of FIG. 6c could be used to enter the sales teams for the company (e.g., using team name and description fields [606][607]). The interface of FIG. 6d could then be used to subdivide the team into specific territories (e.g., using territory name and description fields [608][609]).

Individual stores where media elements would be captured can also be defined, such as shown in the interface of FIG. 6e. In that interface, a user could enter information about a store (e.g., enter a zip code into a zip code field [610]), then use the “create new store” control [611] to add an entry into the database [504] corresponding to the store. The interface of FIG. 6e could also be used to modify data about stores, such as by entering information into the fields depicted, running a search for records in the database [504] having matching information, then selecting a record from the result list (not shown) to modify that record's information. This same approach could also be used to correlate individual stores with sales teams and territories, as shown in FIG. 6f. In that figure, once a store had been defined (or searched and selected, as discussed previously), the administrator could use a “add store” control or similar tool (not shown) to correlate the store with the team and territory indicated by the team and territory selectors [612][613].

Of course, it should be understood that an administrator could perform additional (or alternative) tasks other than those discussed in the context of FIGS. 6a-6f. As an illustration of this, consider the interfaces of FIGS. 6g-6h. FIGS. 6g and 6h illustrate interfaces that can be used to set tags that describe media elements to be captured by mobile devices [501] and uploaded to the database [504]. In particular, FIG. 6g shows an interface which could be used to set categories of tags. For example, product name, product quality, product price, whether the product is in stock, or other tags which might be appropriate in a given situation. The interface of FIG. 6h could then be used to set the potential values for those tags. For example, the “product name” tag could be given potential values corresponding to the company's (or division's, or other organization unit's) products. The product quality tag could be given potential values corresponding to a scale for the product (e.g., is a fruit unripe, ripe, or spoiled). Additionally, information to facilitate selection of tags could also be provided. For example, in a case where a product is to be tagged with a rating on a scale (e.g., a quality scale from 0-10), media elements exemplifying various locations on the scale (e.g., pictures of products having ratings of 0, 1, 2, etc) could be uploaded and then provided on mobile devices as exemplars. A benefit of this approach is that no specific set of tags and values is required to apply to all businesses, and little or no advance knowledge of tags by individuals tagging media elements is required. Instead, the individual businesses have the option of customizing their own tags, and the values those tags can take.

In accordance with a various embodiments, there is not necessarily a limit on the number of tags that may be created by the administrator (or other user creating tags). Various users may wish to utilize a relative large number of tags (i.e., more than 100), while other users may only require a relatively small number of tags (i.e., less than 5). Thus, the systems and methods described herein are not limited to any particular maximum number of tags that may be created.

An additional level of flexibility is provided by the start and end date fields [614][615] included in the interfaces of FIGS. 6g and 6h. Using such interfaces, tags and tag values can be defined in a manner where they will automatically be presented to mobile devices [501] when they are appropriate, and only when they are appropriate. For example, consider a tag (or tag value) set for a seasonal promotion, such as a Christmas sale. Using start and end date fields [614][615], the tag or value could be set in advance, such as late August. Then, when the start date comes, the new tag values could be automatically pushed to the mobile devices [501] for use in identifying media elements relating to the promotion. Similarly, when the promotion is over, a command could be automatically pushed to the mobile devices [501] telling them to disable (e.g., by deleting) the tag or value which is no longer operative. Of course, it should be understood that this deactivation (e.g., by deletion) of tag values does not mean that tags which have been deactivated are completely lost to the system. For example, in some implementations, after a tag has been deactivated, it could still be searched for (such as using interfaces as shown in FIG. 9a, infra) and used for organizing media elements as if it had not been deactivated. Thus, in various embodiments, historical tags may be searched in addition to the presently active tags.

A similar start and end date approach can also be applied to instructions that can be provided to users of mobile devices [501] regarding media elements that should be captured and uploaded to the server [502]. Examples of interfaces which could be used to define such instructions, potentially along with start and end dates, are provided in FIGS. 6i-6k. Starting with the interface of FIG. 6i, that interface could be used for defining alerts that would be pushed to the mobile devices [501] as highest priority tasks. For example, if a manufacturer were required to perform a product recall, then instructions to take pictures to verify compliance with the recall could be sent out as an alert. In such a case, the alert could be sent to all mobile devices [501], or could be focused on a particular subset using the division, team and territory selectors [616][617][618]. In the event the alerts are focused on a particular subset, then, when a user logs into server [502] using a mobile device [501], the server [501] could check to see if the user is associated with the specific subset and, if the user was associated with the subset, would push the alert to the mobile device [501].

FIG. 6j illustrates an interface which could be used for defining non-alert instructions (called priorities) to be pushed to appropriate mobile devices [501]. As with the alert interface of FIG. 6i, the priority interface of FIG. 6j includes division, team and territory selectors [616][617][618] which can be used to focus which mobile devices [501] the instructions should be pushed to. Additionally, the priority interface of FIG. 6j includes a sorting selector [619] which can be used to specify how the different priorities are displayed on the mobile device [501] (e.g., if multiple priorities are provided, they could be presented in a list, where a priority with a priority order of 1 could be displayed above a priority with a priority order of 3).

Other types of instructions, and interfaces to define them, could also be used. As an illustration of this, consider FIG. 6k, which depicts an interface which can be used to define promotion instructions. In that interface, there are specialized fields for promotion text [621], and tags that could automatically be associated with media elements that are taken as part of the promotion [620]. In cases where there is a separate promotion interface, such as shown in FIG. 6k, the applications on the mobile devices [501] which are used to interact with the server [502] could be configured to present an interface which would be specifically designated for capturing media elements associated with promotions. When a media element is captured via that interface, the media element could automatically be “tagged” with the name of the promotion, thereby removing the necessity for separate tags.

Of course, as shown by the tag association field [620], media elements associated with a promotion could also be tagged in the manner of regular media elements, and so the description of a separate type of interface and automatic tagging for media elements associated with promotions should be understood to be illustrative only, and not limiting. Further, it should be understood that the promotion interface of FIG. 6k is intended to be illustrative only of a type of interface which represents a recurring type of subject matter that would be of interest to customers, and should not be treated as implying that the only type of interface other than the alert and priority interfaces of 6i and 6j which is envisioned by the inventors is the promotion interface of FIG. 6k. As a result, the disclosure above related to the promotion interface of FIG. 6k should be understood as being illustrative only, and not limiting.

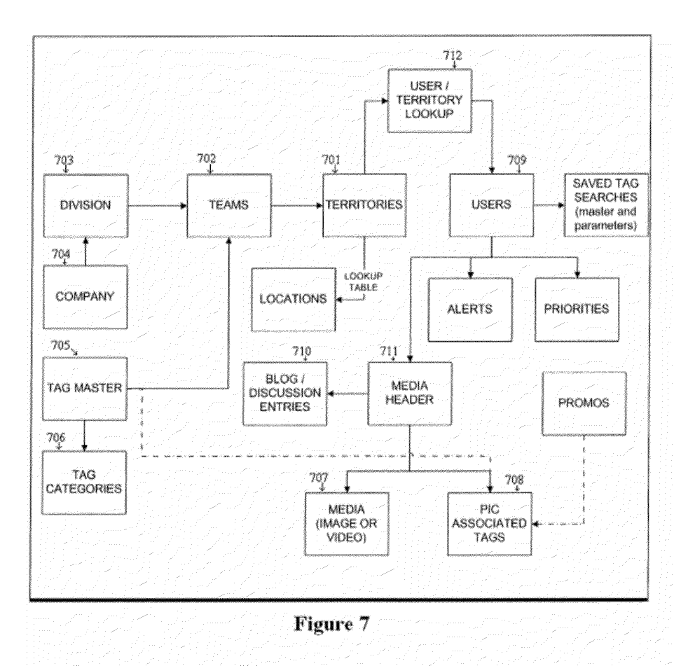

Regardless of what interfaces are used, when information, such as information which could be entered using the interfaces of FIGS. 6a-6k, is provided, in one embodiment of the inventor's technology, it will be stored in a database [604]. One way such a database [504] can be organized to facilitate this data storage, as well as subsequent data retrieval and/or mining, is shown in the entity relationship diagram of FIG. 7. In a database [504] organized according to FIG. 7, there could be specific entities (e.g., objects in an object oriented database, or tables in a relational database) which correspond to the interfaces described above, such as for territories [701], teams [702], divisions [703] and companies [704]. Those entities could then be linked to one another to facilitate the retrieval and/or manipulation of the data, such as with pointers extending up the hierarchy of a company (e.g., a territory [701] would include a pointer to an object/table for its team [702], which would include a pointer to an object/table for its division [703], which would include a pointer to the object/table for its company [704]). This approach, using pointers extending up a hierarchy, could be beneficial in cases where it may be necessary to retrieve information after being provided with data about a lower level of the hierarchy (e.g., when a user logs in and indicates an associated team or territory), since it would obviate the need to perform lookups at higher levels of the hierarchy to trace a path from those levels to the information provided. Of course, in an implementation which is based on the requirements of a business that does not use the same organization discussed above (e.g., one which does not include a separate hierarchy level for divisions), the database organization shown in FIG. 7, as well as the interfaces discussed previously, could be modified to reflect the requirements of that business.

In addition to including entities reflecting the organizational structure of a business (e.g., the company objects/tables [704] discussed above), the diagram of FIG. 7 also includes entities which can be used to label media elements that are uploaded using mobile devices [501]. For example, as shown in FIG. 7, there could be a tag master entity [705], which would contain all of the values for tags defined in the system. Such an entity could, in turn, be linked to one or more entities representing tag categories [706] (e.g., a tag value could be something like high, low, medium and out of stock, while a tag category could be something like inventory level). The database [504] could also include objects for media elements [707] and the tags [708] they were associated with at the time of upload. Further, as shown in FIG. 7, the media elements [707] could be associated with individual users [709] (e.g., the users who uploaded them) and data subsequently added to those elements (e.g., comments [710]) through a header object [711]). This could be beneficial in implementations which include functionality such as searching for media elements taken by a particular user (or taken by users in a particular territory, using the user/territory lookup [712]). Of course, other organizations are also possible, based on the types of data retrievals/manipulations that might be required in a particular instance. Accordingly, the database structure shown in FIG. 7 should be understood as being illustrative only, and not limiting.

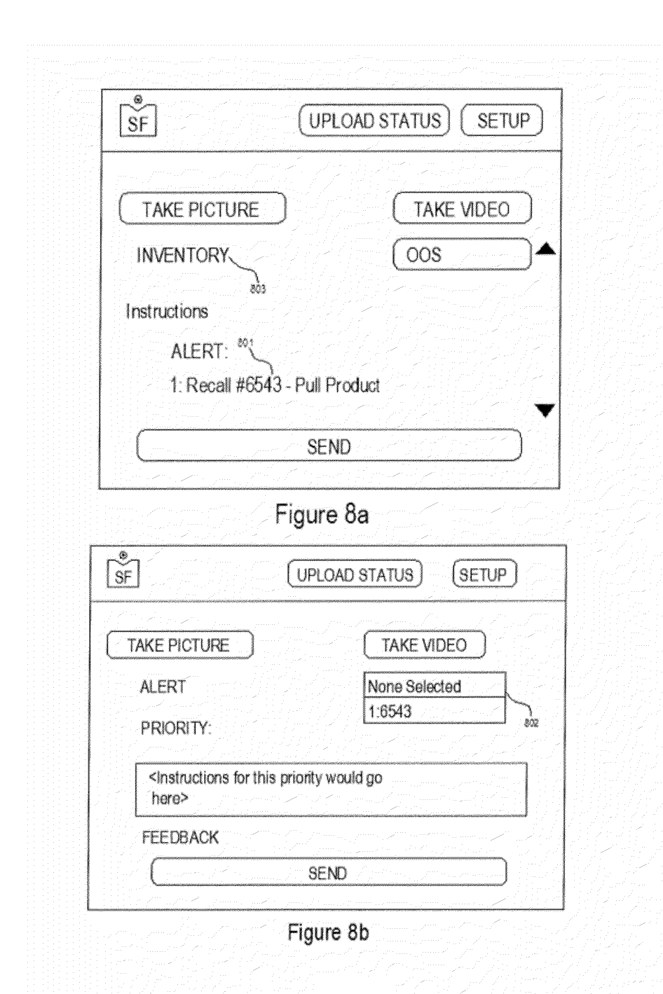

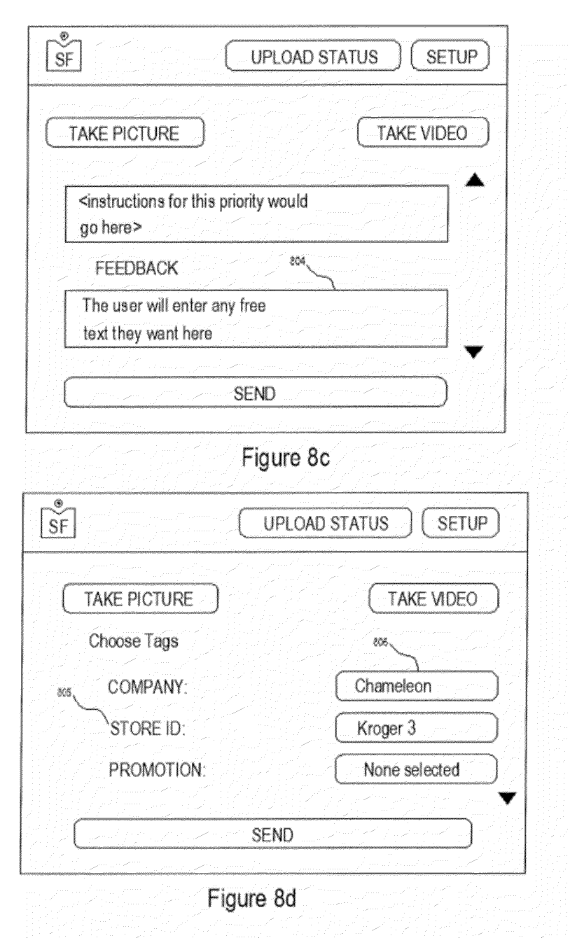

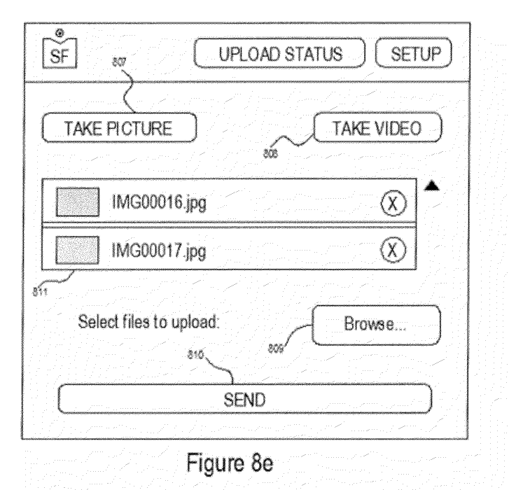

Turning now to FIGS. 8a-8e, those figures present interfaces which could be presented on a mobile device [501] to allow a user of the device to capture and upload media elements to a database [504]. Starting with FIGS. 8a-8b, those figures present interfaces which can provide instructions for a user of a mobile device [501]. FIG. 8a shows an interface which could be presented to a user when an alert had been defined. As shown in FIG. 8a, the interface can include instructions [801] defining the content of the alert, such as a requirement to pull products from a shelf in accordance with a recall. Also, note in FIG. 8a the tag label [803] for the custom inventory tag. This could be displayed in the event that, when the alert shown in FIG. 8a was defined, it was associated with an inventory tag category, which included values such as out of stock (OOS, shown in FIG. 8a).

FIG. 8b shows a similar type of interface which can be used for providing instructions on priorities. In one method of operation, a priority interface such as shown in FIG. 8b would automatically be presented when a user logs on to a mobile device [501]. In this mode of operation, the interface would show the priorities, as well as any alerts which had been defined (e.g., alert 6543, as shown in the alert selector [802]) in a single display for the user. The user could then perform the activities associated with any alerts, then proceed down the priorities in order of their importance. Alternatively, in some implementations, an interface presenting priorities to a user might only be displayed once the user had completed any applicable alerts (or if no alerts had been defined). Either way, an interface such as shown in FIG. 8b may be dynamically created by an application resident on the mobile device [501] in response to data pulled from the database [504] at the time the user logged into the mobile device [501] and initially connected to the database (though alternatives, such as generating the interface on the server [502], and pushing it to the mobile device [501] are also possible).

Turning now to FIGS. 8c-8d, those figures depict interfaces which could be used by a user of a mobile device [501] to communicate data to a database [504] in addition to uploaded media elements. For example, FIG. 8d shows an interface which can be used to select tag values for a media element to be uploaded. In that figure, the tag categories [805] which had previously been defined for the company (or division, or other organizational unit which is appropriate for the implementation in question) are listed on the right side of the interface, while the potential values [806] for those tag categories are provided on the right. In operation, an interface such as shown in FIG. 8d could provide selection tools (e.g., drop down menus) to allow the user to select appropriate tag values [806] to be appended to a media element before it is captured and uploaded to the database [504]. FIG. 8c depicts a control which can be used to provide another type of metadata when a media element is uploaded to a database [504]. In particular, FIG. 8c depicts a feedback control [804], which can be presented by an interface on a mobile device [501] to allow the user to provide additional information that might not be conveyed by tags. For example, instructions provided to the user of the mobile device [501] might have included a question that would not be answered simply by tagging a media element, such a question on how the price of the pictured product compares to the prices of competing products in the store. The feedback control [804] could be used to answer that question (or other questions provided with the priority instructions, or to provide other information that could be seen as positively or negatively affecting the product being pictured in the uploaded media elements).

Finally, once a user had logged into a mobile application, received his or her instructions, and specified any necessary metadata using interfaces such as discussed in the context of FIGS. 8a-8d, he or she could use an interface such as shown in FIG. 8e to actually capture and upload the appropriate media elements. In the interface of FIG. 8e, there are controls for facilitating two separate approaches to capturing and uploading media. The first, which could be actuated with the take picture [807] and take video [808] controls, is to utilize capture technology which is built into the application on the mobile device [501]. When those controls are actuated, the mobile device [501] could capture the appropriate media element, and it would automatically be added to an upload queue [811] to be sent to the server [502] and stored in the database [504]. Alternatively, the user of the mobile device [501] could use the browse control [809] to identify media elements that had previously been stored on the mobile device (e.g., after being captured using a different application), and have those media elements added to the upload queue [811]. Finally, once all of the appropriate media elements had been captured and added to the upload queue, they could be sent to the server [502] using the send control [810], at which point they would be packaged with the appropriate metadata and uploaded so that they could be reviewed in real time.

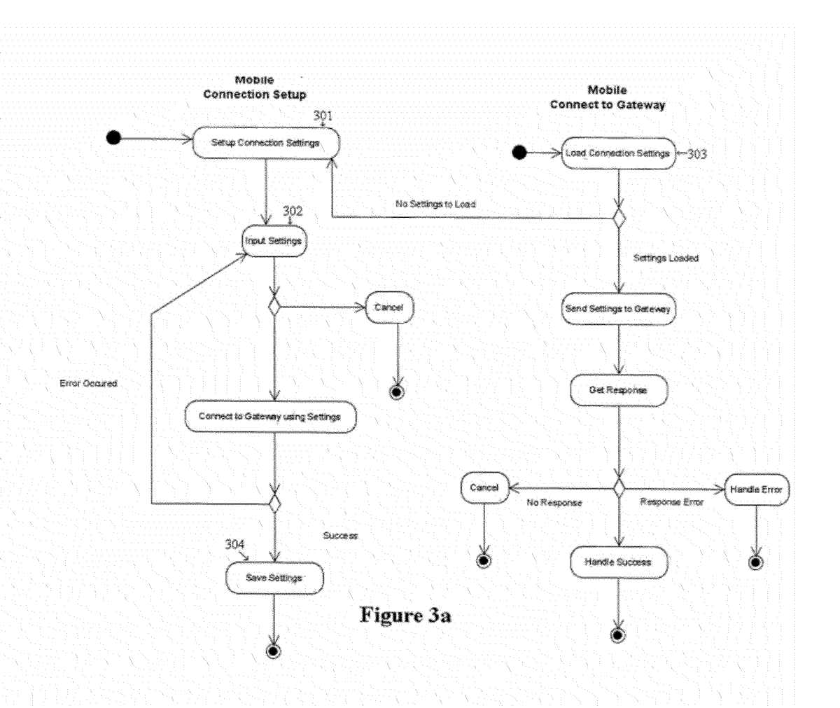

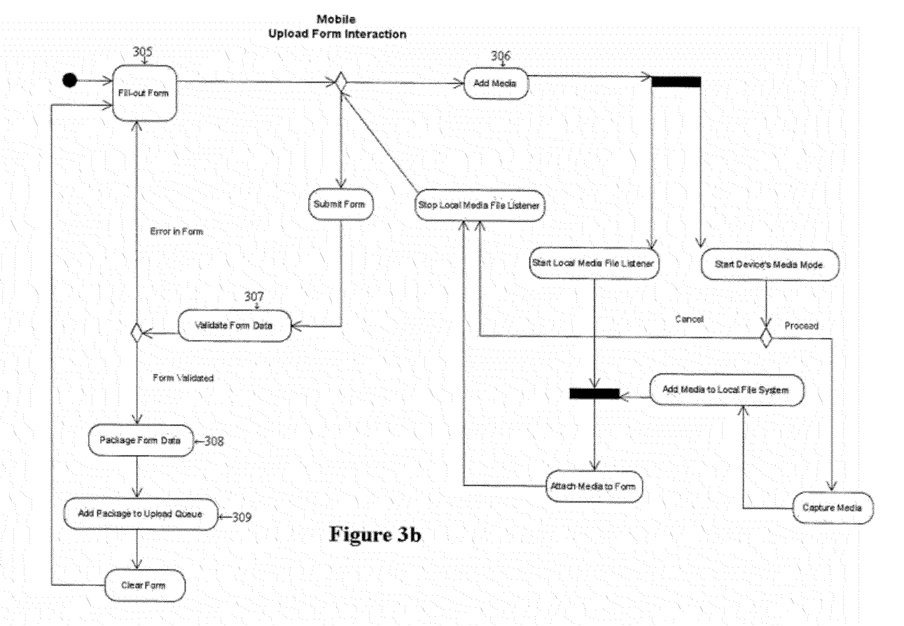

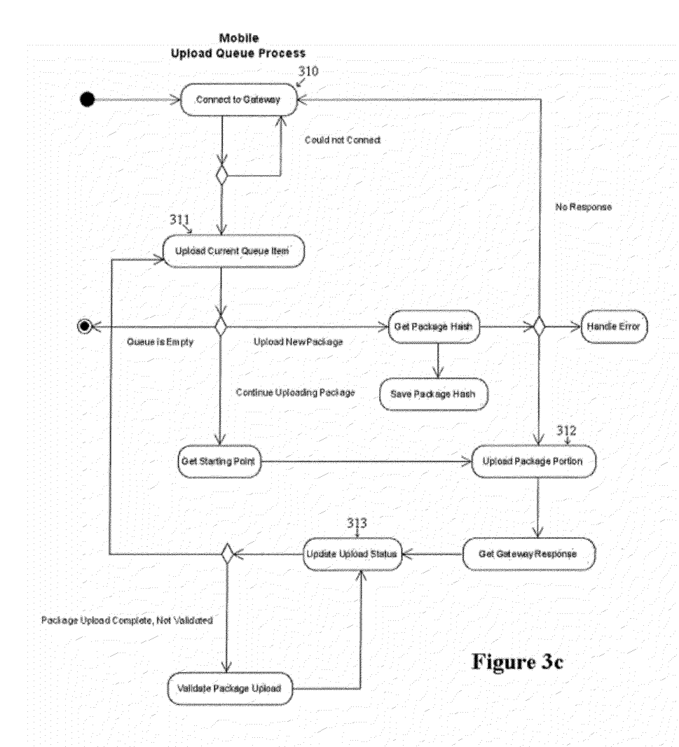

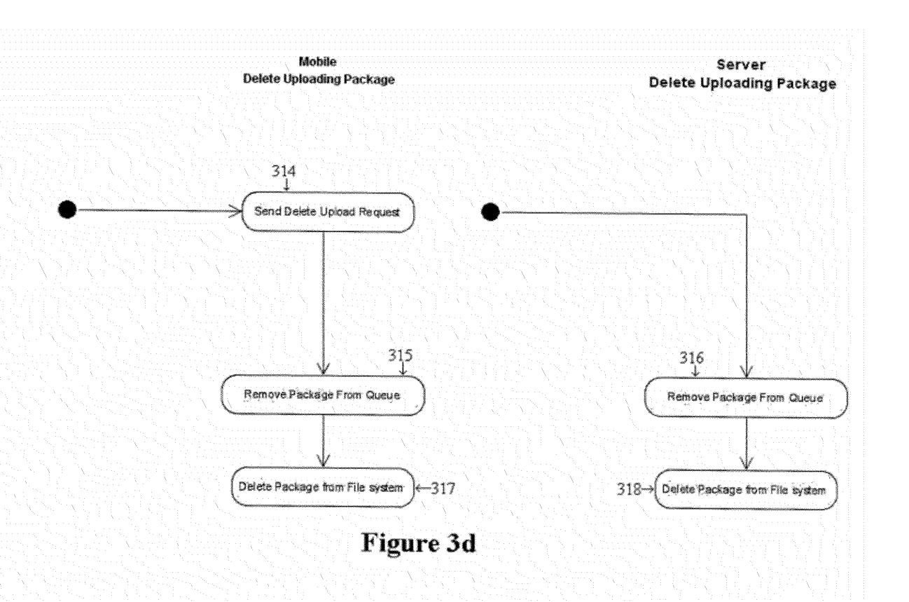

As a further illustration of how a mobile device [501] could be operated in accordance with the disclosed technology, consider FIGS. 3a-3d. FIG. 3a depicts activities which might take place in establishing a connection between a mobile device [501] and a server [502]. These include steps like setting up connection settings [301] with the server [502]. If this is the first time the user has established a connection from the mobile device [501], then these connection settings can be inputted [302] (e.g., entering the user name and password of the user of the mobile device [501], as well as network address for the server [502]). Alternatively, if the user has already used the mobile device [501], and has saved connection settings previously [304], these settings could be loaded [303] and used rather than having to be separately input [302].

Once the connection with the server [502] had been established, the user could use the mobile device [501] to determine data for upload, such as by filling out a form [305] with appropriate metadata, and adding media [306] to that form. Once the form had been filled out [305] and the media captured [306], the application on the mobile device [501] could validate the form data [307], such as by verifying that any media elements to be uploaded had been tagged. The data could then be packaged into the proper format (e.g., mapped into a data structure having fields corresponding to columns in a table in the database [504]), and added to an upload queue [309].

Once a package has been added to an upload queue [309], the process can continue with the steps shown in FIG. 3c. In the diagram of FIG. 3c, the first step shown is establishing a connection with the gateway (e.g., an application on the server [502]) [310]. This step could be useful in implementations in which, after a mobile device [501] connects to a server [502] using steps such as shown in FIG. 3a, the initial connection with the server [502] is terminated (e.g., to save network charges after any new instructions and/or tags have been downloaded to the device). In other implementations, such as implementations where the mobile device [501] maintains a continuous connection with the server [502] until the user affirmatively logs off, the step of connecting to the gateway [310] may not be necessary. Whatever the case, once a connection exists, and there are items in an upload queue, the items in that queue can be uploaded, starting with uploading the current item [311]. Once the current item is uploaded [312], the upload status on the device [501] would be updated [313], and the process could repeat, with a new current item being uploaded [311] until such time as the upload queue is empty.

Finally, when the upload is complete, the steps shown in FIG. 3d can be used to remove the upload's remnants from the mobile device [501] and the server [502]. Specifically, once the upload is complete and confirmed, the mobile device could send the server a delete upload request [314]. The mobile device [501] and the server [502] could then remove the packages from the queues in their respective local memories [315][316], and also delete them from their respective file systems [317][318], thereby leaving the database [504] as storing the master copy of the uploaded information, and freeing up the resources of the server [502] and mobile devices [501].

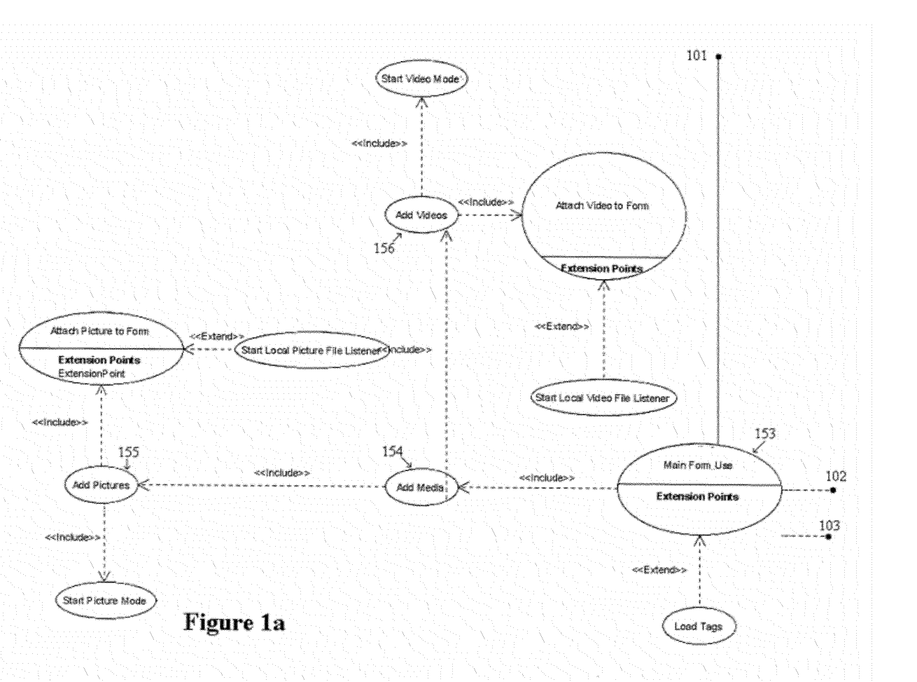

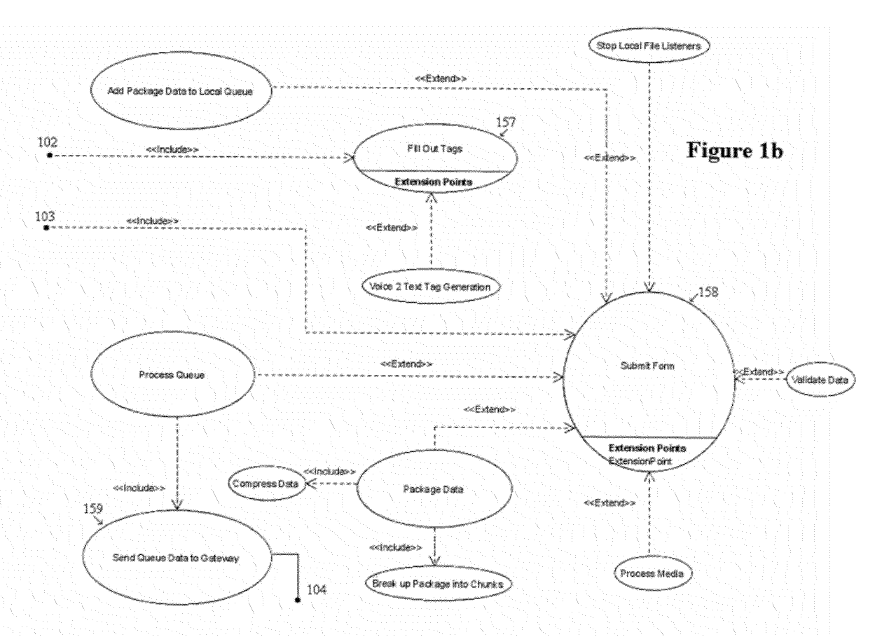

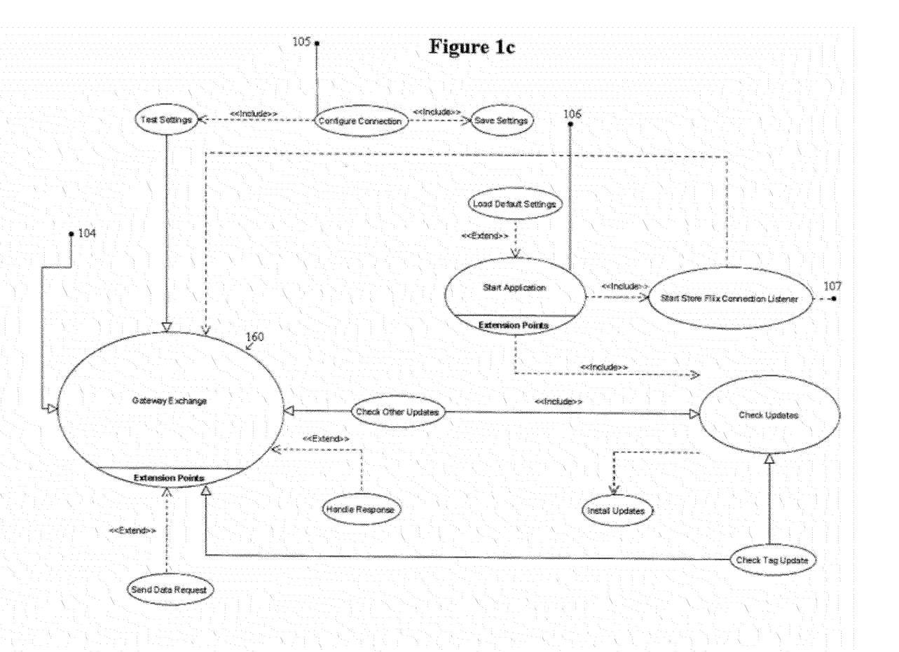

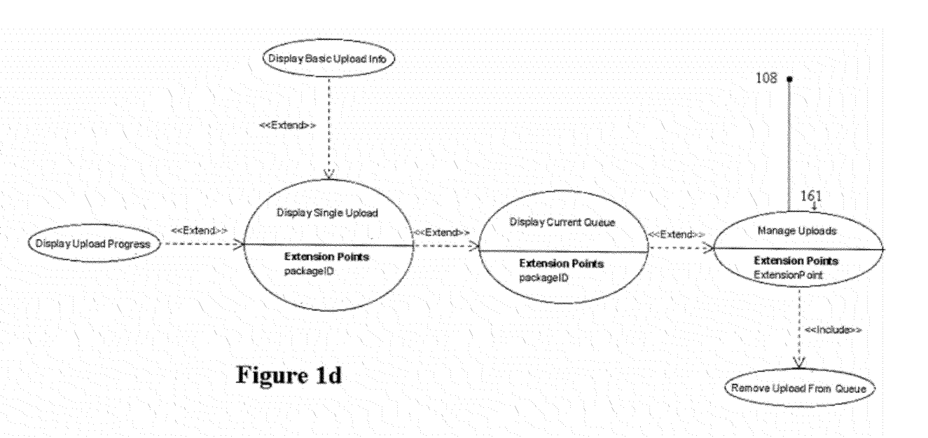

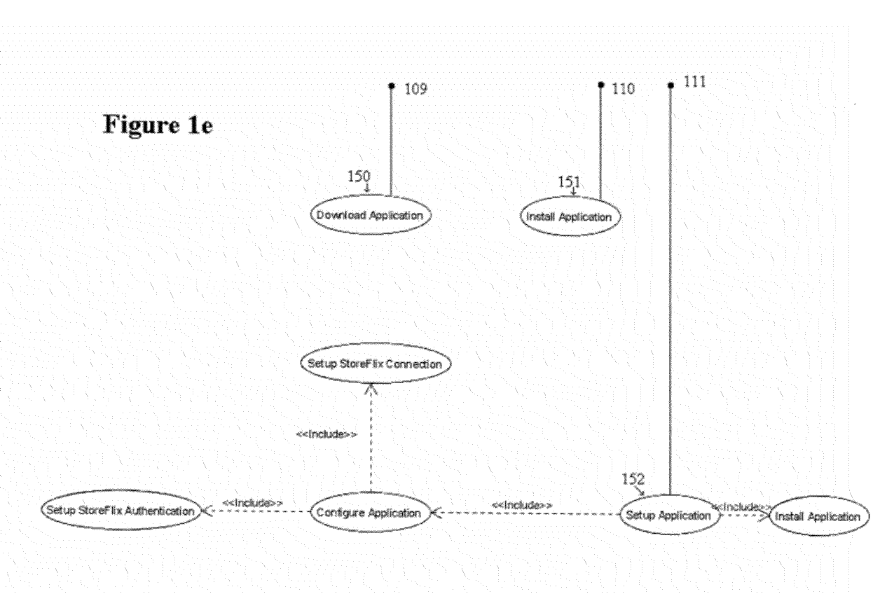

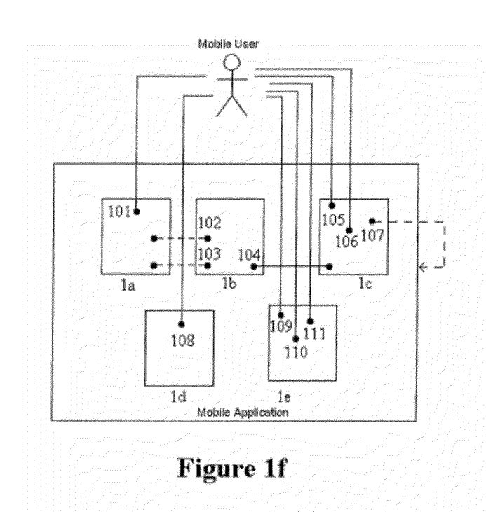

In terms of software, FIGS. 1a-1f illustrate how software to support activities such as described above with respect to FIGS. 3a-3d could be organized. FIG. 1e depicts various modules would could be used to prepare a mobile device [501] for use, such as a module for downloading an application [150] would could be used to provide interfaces and perform functions such as described above. This downloading module [150] could be implemented using any suitable type of technology known in the art, such as a browser which could perform an FTP transfer from a download location (e.g., the server [502]). Once the necessary data had been downloaded, the application could be installed [151] on the device [501]. This installation could also be performed using known tools, such as wizards and installation utilities. There could also be a setup utility [152], which might be executed as part of the installation (or, as shown in FIG. 1e, it is also possible that the installation could take place in the process of setting up the application). This setup utility [152] could be used to configure the application, such as by informing it of how the mobile device [501] should connect and authenticate itself to the server [502]. The connections [109][110][111] shown in FIG. 1e illustrate functions in FIG. 1e which would be actuated by a user, as shown in FIG. 1f.

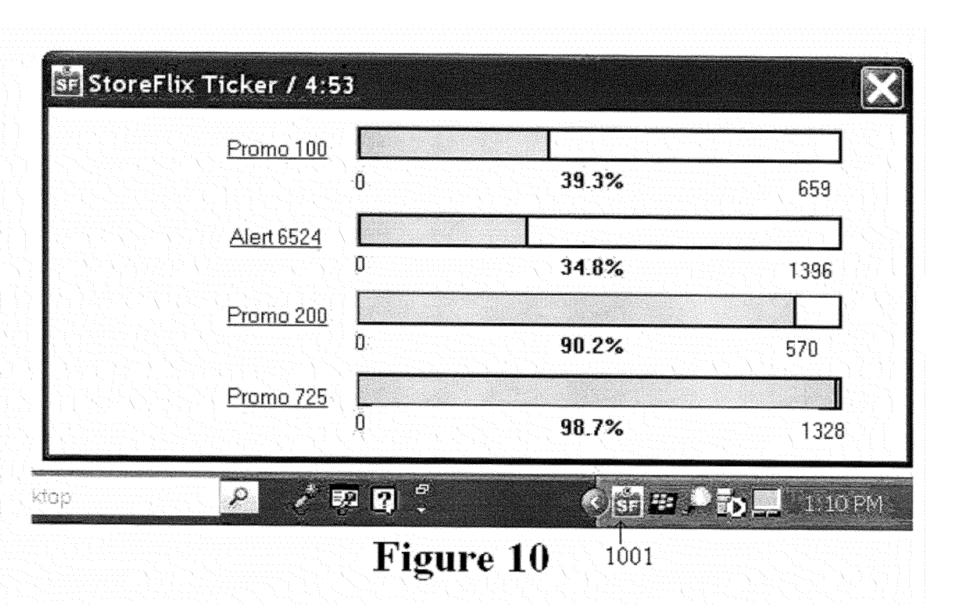

FIG. 1a then depicts how software which can be used in capturing and adding media elements on a mobile device [501] could be organized. As shown in that figure, the software used to support tasks of the mobile device described above can be organized in a manner which parallels the tasks themselves. For instance, there could be a class and/or module which corresponds to use of the main form [153] illustrated previously in the context of FIGS. 8a-8e. Such a class and/or module could in turn be supported by different modules which correspond to particular activities, such as an add media module [154], which could be used to provide functionality of modules for adding pictures [155] and video [156]. In FIG. 1a, the connection at the top of the figure [101] illustrates that certain modules would be actuated by the user (as indicated in the overview of FIG. 10, while the connections at the right side of the diagram [102][103] illustrate connections with the diagram of FIG. 1b. As shown by those connections, modules in FIG. 1b, including a tag filling module [157] and a form submission module [158] can be used to support the main form use module [153] from FIG. 1a. Similarly, as shown in FIG. 1b, the module used to send data to the gateway [159] can interact with other modules, as indicated by the connection [104] in the bottom of FIG. 1b. This corresponds to the same connection [104] in FIG. 1c, which illustrates the interaction with a module used to exchange data with a gateway [160]. Similarly, in FIG. 1c, the connections at the top of that figure [105][106] indicate certain modules whose functionality would be actuated by the user, and the connection at the right side of the figure [107] indicates a module which would modify the activities of the mobile application itself.

Finally, FIG. 1d shows a module which can be used to manage uploads [161], and a connection [108] indicating that that module can be actuated by the user of the mobile device [501]. Allowing such a module to be actuated by a user could be beneficial in situations where the ability to communicate between a mobile device [501] and a server [502] may be unreliable. In such a case, rather than having the upload management module [161] called directly from the form submission module [158], the user could call the upload management module at a later time, such as when a reliable network connection is available. Of course, it should be understood that this type of approach is intended to be illustrative of a potential implementation of the system, and that it is also possible that the upload management module [161] would be automatically called when the form submission module [158] is activated by the user. It should also be understood that the disclosed technology is not limited to implementations in which the connection between a mobile device and a server is unreliable. For example, in one embodiment, the mobile device [501] will be a smartphone which can use a cellular telephone connection to reliably communicate with the server. Further, other variations on the module organization illustrated in FIGS. 1a-1f are also possible. For example, as shown in FIG. 1a, the main form module [153] would likely include functionality to allow the user to add media to the form [154]. As a result, even though this functionality is not specifically identified by an external connection, it should be understood that the functionality will also likely be available to the user.

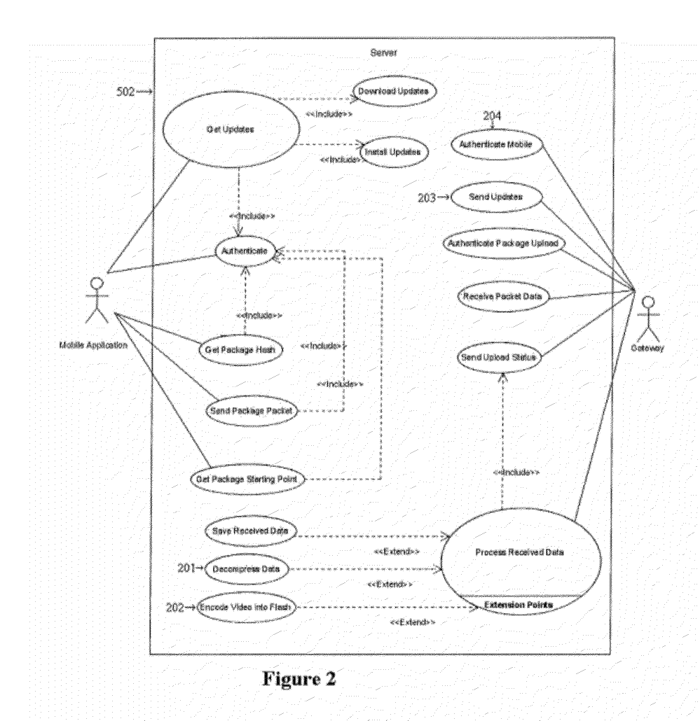

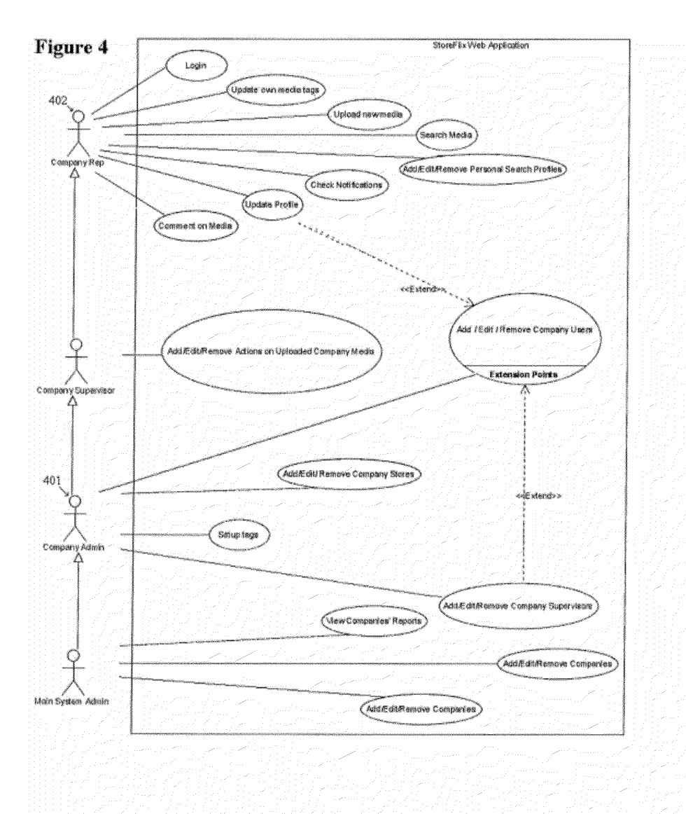

FIGS. 2 and 4 provide a different perspective for how interactions using aspects of the technology described herein can take place. FIG. 2 depicts how an application on an end device [501] can interact with modules provided by a gateway application on a server [502]. As shown in FIG. 2, the modules (and corresponding activities) are not necessarily limited to uploading functions, but might also include various types of authentication and updating for the mobile application as well. Similarly, FIG. 2 also depicts activities which could take place on the gateway side of the interaction, such as decompressing data received from the mobile device [201], converting video into more easily viewable formats (e.g., flash) [202] or sending updates to or authenticating the mobile device [203][204]. It should be noted that the activities shown in FIG. 2 could be supported by a variety of underlying architectures. For example, a gateway could be implemented on a dedicated machine which would act as a point of contact for a mobile device [501] before passing information on to a server [502] with access to a centralized database [504]. Alternatively, a gateway could be implemented as an application running on a server [502], which would be dedicated to communicating with mobile devices [501]. As yet another alternative, a gateway could be implemented as a web site or other interface which could be accessed by mobile devices [501] and by other devices such as computers [505][506] used by employees of a manufacturer. In such a case, the gateway could be split into dedicated portions where one portion of the gateway would be used for communicating with mobile devices [501] and receiving data from remote locations, while another portion of the gateway would be used for viewing and analyzing data received from mobile devices [501] by employees of a manufacturer. Other variations, such as gateways which provide common (or dedicated, such as using child sites) interfaces for many manufacturers, and gateways which act as automated interface points that would be automatically accessed by mobile devices [501] are also possible. Accordingly, the above discussion should be understood as being illustrative only, and not limiting.

Turning now to FIG. 4, that figure depicts how different users, having different roles, can interact with a web application to access, upload, comment on, edit or otherwise use media in the system. For example, as shown in FIG. 4, a company administrator [401] could have the responsibility for setting up tags which would later be used by a company representative [402] to organize and identify media uploaded from a mobile application. The company administrator [401] may set up any number of tags necessary for a particular implementation, such as 5 tags, 20 tags, or 1000 tags, for example. Similarly, different users could view reports or search the media stored on the server [502] or database [504], or modify permissions to add users to the system, or to change what activities individual users are allowed to perform. Further, it is also possible that users beyond those depicted in FIG. 4 could interact with a web application such as shown or could be implemented according to this disclosure. For example, there could be a product manager who would be able to access the web application to determine how the products that he or she was responsible for were displayed relative to their competition. Other types of uses, some of which are described below, are also possible. Accordingly, neither FIG. 4, nor the accompanying disclosure, should be understood as implying limitations on potential uses for the technology disclosed herein.

Turning now to FIGS. 9a-9d, those figures illustrate interfaces which can be presented on end computers [505][506] to allow employees of a manufacturer to search, comment on, examine, and otherwise use media elements which have been uploaded from mobile devices [501]. FIG. 9a illustrates an interface in which a user can define a search for media elements based on a set of tag values [901] which had previously been defined for tag categories for the user's company. After the tag values are set, if the user actuates the search control [905], all media elements stored in the database [504] which had the appropriate tag values (and which the user had appropriate permissions to examine) would be presented to the user on a search result screen, perhaps with additional information, such as when, where and by whom the media elements were captured. In some embodiments, the search for media elements may additionally (or alternatively) be based on one or more historical tag values. In other words, searching may be performed on tag values that are not necessarily currently active.

An interface such as shown in FIG. 9a could also allow a user to run a search for media elements using other types of data, such as dates the media element is uploaded, number of comments on the media element, and/or keywords associated with the media element (e.g., through a keyword control [902]). For instance, if a keyword search was executed, then the system could retrieve media elements from the database [504] which were associated with textual information that included the specified keyword(s), such as in comments made when the media element was uploaded, in comments made subsequently on the media element, or in the instructions provided to the user of the mobile device [501] which resulted in the media element being captured. FIG. 9a also illustrates a profile control [903]. Using an interface as shown in FIG. 9a, after a user has defined the parameters of a search, he or she could potentially save those parameters using the profile creation tool [904], so that an identical search could be run without having to re-define the same parameters. Other profile based functionality could also be implemented. For example, users could be allowed to share profiles with one another, or to specify search profiles to be run on a periodic basis to generate reports on media elements which had been uploaded to the database [504]. Other variations, such as providing default profiles for users, or providing users data on popular profile parameters to help optimize searches are also possible. Additionally, in some cases, users could even be provided with information on popular profile parameters, to help optimize searches for those users. In terms of display, a variety of approaches are possible, including drop down menus (shown in FIG. 9b), directory trees, or other types of displays known to those of ordinary skill in the art.

Turning now to FIG. 9c, that figure illustrates an interface that can be provided in some implementations for after a search for media elements has been completed. For example, a user could be presented with an interface as shown in FIG. 9c after selecting a media element returned as part of a search result. In that interface, the user could then be presented with a comment control [906], which could be used to post feedback on the media element which was selected. Once the feedback had been added using the control, it could then be associated with the media element in the database [504] (e.g., though a media header [711] as a blog or discussion entry [710]) so that other users could later examine that feedback when the select the media element.

Additionally, it is possible that a feedback control [906] as shown in FIG. 9c could be used to provide real time communication with a user of a mobile device [501] (e.g., messages such as take a picture from a different angle, or take a video of customers interacting with a promotional display, etc). For example, in some implementations, when feedback is added to a control [906] as shown in FIG. 9c, the server [502] could be programmed to examine if the user who posts the feedback is different from the user who uploaded the media element being commented on. If the users are different, the server [502] could check if the user who uploaded the media element being commented on is reachable for real time communication. If the user is reachable, the comment could be sent to the user of the mobile device, so that the people viewing the media element can provide real time feedback or additional instructions (e.g., by having a text message displayed on the mobile device, or by automatically initiating a voice connection between the computer being used to add the feedback and the mobile device used to upload the media element). Of course, the use of an interface such as shown in FIG. 9c to provide communication with the individual who uploaded a media element is not limited to real time communication. For example, in some cases, rather than checking if the user was available for real time communication, once the feedback was added through the feedback control [906], an email would be sent to the person who uploaded the media element, potentially including a link to the media element that the feedback was made on. Additionally, in some implementations, combined approaches could also be used. For example, an interface such as shown in FIG. 9c could include an icon which indicates if the individual who uploaded the media element is available for real time communication, and would route the feedback to that individual differently depending on whether real time communication is possible.

In terms of supporting real time communication, there are a variety of approaches that could be taken in different implementation. One example is a polling based approach. In this type of approach, the devices at either end of the system (i.e., the mobile devices [501] and the end user computers [505][506]) could periodically poll the database [504] and update information based on the result of that polling. To illustrate, consider the case where an administrator creates new tags or tag values, and wants them communicated to a mobile device [501]. As discussed previously, when a user of a mobile device [501] starts up the mobile application on that device, the application can automatically seek to connect to the server [502] and download updates. However, this approach will not catch updates sent after the initial connection. To address this, the mobile application could be programmed to periodically (e.g., every 60 seconds) contact the server [502] and ask if there are new updates to download. The server [502] could then identify any data that had been added to the database [504] since the last communication with the mobile device [501], and send that information to the mobile device [501] as a real time update/communication. The database could also include particular information to support this type of real time interaction. For example, when new tags or tag values are added to the database, the database could create a table which indicates, for every user who should have those tags or tag values sent to their mobile applications, whether those tags or tag values have been sent. In such a case, when a server seeks to find what information (if any) should be sent to a mobile device in response to being polled, all that would be necessary is to check the appropriate values in the database. Similar polling could be performed from the end computers [505][506], in the event that the users at those computers desired to have real time information about data that had been uploaded to the database by the mobile devices [501].

Polling based approaches are not the only approaches to supporting real time communication that could be implemented in systems following this disclosure. For example, in some embodiments, once a user at a mobile device [501] (or at an end computer [505][506]) connects to the server [502], that connection will simply be maintained until the user affirmatively logs off. Similarly, in some implementations it is possible that the end computers [505][506] and the mobile devices will run applications that listen continuously for messages from the server [502], in which case as soon as information is added to the database [504], the server [502] could establish connections with the appropriate devices, and send them the added data. Further, in some implementations, these approaches could be combined. For example, once a user logs on to a server, rather than maintaining an active connection until the user affirmatively logs off, the server could set a flag indicating that the user is available to receive communications. Then, when information is added to the database, the server could check if that information should be sent to a flagged user and, if so, could establish a connection with the user and send that information to them without waiting to be polled.

Turning back to the interfaces of FIGS. 9a-9d, it should be understood that simply providing the ability to comment on media elements, or to engage in communication as described above, are not the only functionalities that could be provided when a user selects a media element in various implementations of the disclosed technology. For example, as shown in FIG. 9c, in some implementations, when a media element is selected, the user can automatically be presented with related media elements (e.g., media elements uploaded by the same user, or uploaded in temporal proximity to the selected element) in a related element portion [907]. As another example of additional functionality, the user could be provided with the ability to expand the media element selected (e.g., if a search result list includes thumbnails of media elements, this could allow an element to be expanded to full size), or to zoom in on a particular portion of a media element. Accordingly, the discussion above of the functionality of FIG. 9c should not be treated as implying limits on the types of features that might be included in systems implemented based on this disclosure.

It should also be understood that the technology disclosed herein is not limited to allowing users to interact with individual media elements. Additionally (or alternatively) it is possible that some implementations could allow users to review aggregated data derived from media elements, such as using a report interface as shown in FIG. 9d. In the interface of FIG. 9d, a user has used promotion [908] and hierarchy selection tools [909] to indicate that they would like to see how many locations are in compliance with the requirements of a specified promotion (in the case of FIG. 9d, promotion 100). In response, the user has been presented with an automatically generated interface, which shows both the number of locations in (or not in) compliance [910], and the proportion of locations in (or not in) compliance [911]. This report could be generated in a number of manners. For example, in some implementations, when a promotion is created, a master record can be created which specifies whether media elements showing compliance with the promotion have been uploaded to the database [504]. When a report request is made, the system could simply count up the number of locations where the master record indicated that no media elements had been uploaded to generate a chart such as shown in FIG. 9d. Additionally, in some cases, there could be functionality which would allow the data shown in FIG. 9d to be updated in real time. For example, there could be a process which would propagate changes to the database [504] to any reports being viewed as they were being made, or there could be a process which would periodically query the database [504] to see if changes had been made which were relevant to a report.

It should be understood that various implementations could use tools other than the interface of FIG. 9d to illustrate compliance with promotions at remote locations. For example, in some implementations, when a media element is uploaded to the database [504], the location of the mobile device [501] where the media element was captured could be uploaded as well, such as in the form of geo-tagging (e.g., latitude and longitude) data that would be added to the media element's metadata. In such implementations, there might be support for showing a user a map which features the location of each of the remote locations which the data in the database [504] indicates is not compliant (or which has not been established as compliant yet). Also, in some implementations a map which shows non-compliant locations might be overlaid with other relevant data, such as color coding showing territories of sales representatives, areas where competing products have been introduced, areas where a new marketing company has been retained, etc, depending on what information is available to correlate against geographic location information in the database [504]. As with the compliance reports illustrated in FIG. 9d, in an embodiment, these additional types of interfaces will also be updated in real time with new information as it is added to the database.

Of course, while the disclosure above focused on the creation of compliance reports based on promotions, it should be understood that similar functionality can be applied to other types of metadata in the database. For example, consider the case where a user desires to have a report on prices at remote locations. In such as case, the user could be presented with a graph showing the proportions of remote locations where media elements having each of the individual tag values for the tag category of price had been uploaded. Similarly, in a geographic report interface, individual locations on a map could be marked with distinctive markers (e.g., different shape, different size, different color, etc) depending on the tag value for the tag category being tracked which was uploaded with media elements from those locations. A similar approach could also be taken with comments, where a report could show how many comments had been made on media elements from particular remote locations, could show the number of locations where at least one uploaded media element had been commented, or could provide other system usage tracking data. Accordingly, the approach described above, which focused on promotions for reporting purposes, should be understood as being illustrative only, and not limiting.

Other types of variations are also possible. For example, the disclosure above focused on illustrating the inventor's technology using dedicated interfaces which could be presented to allow users to perform certain functions. However, the inventor's technology is not limited to being accessed using those types of interfaces. For example, as shown in FIG. 10, some implementations could include icons [1001] which are displayed in a user's system tray, much like instant messaging applications. Such icons could allow the user to access their alerts or promotions to check for compliance (which could be determined as described above) without having to go to a web site. In particular, when the system tray icon [1001] is selected, the user could be presented with a display as shown in FIG. 10 which provides compliance information on selected alerts and promotions on a percentage basis. Further, in some implementations which include displays as shown in FIG. 10, the labels on the types of metadata being tracked (alerts and promotions in the diagram of FIG. 10) could be hyperlinked directly to a dedicated interface (e.g., as shown in FIG. 9d), so that when the user clicks on the labels they can automatically be logged into the custom web site and redirected to a page showing the compliance for the report or promotion selected.

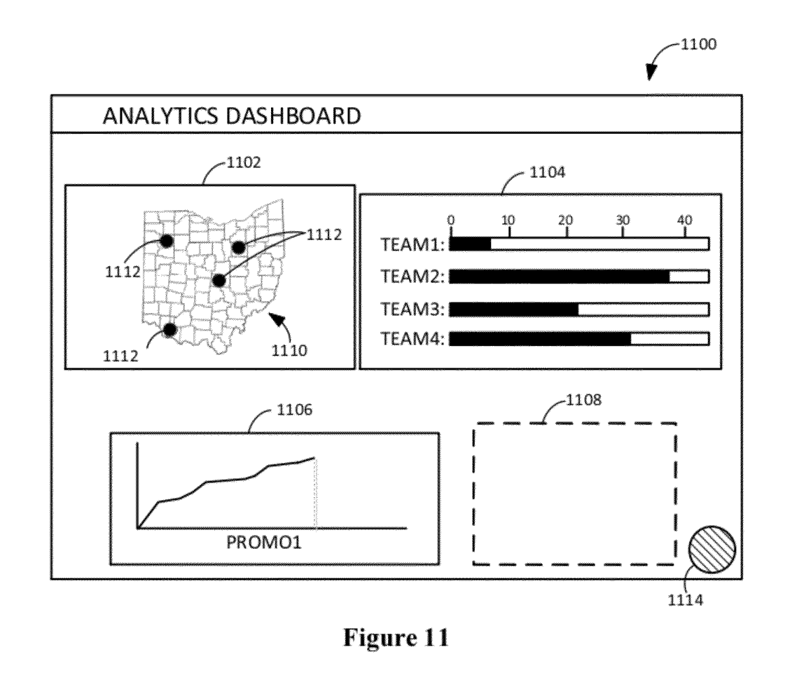

FIG. 11 depicts a non-limiting example embodiment of a visual analytics interface which may be presented to a user. In the illustrated embodiment, an analytics dashboard [1100] may be presented to the user. The information presented via the analytics dashboard [1100] may be updated in real-time (or substantially real time) through periodic queries to various databases storing the associated data. For example, the information on the analytics dashboard [1100] may be updated every second, every minute, or any other suitable refresh rate. In some embodiments, a refresh button or icon may be presented to the user that, when activated, cause the data displayed in the analytics dashboard [1100] to be updated. Furthermore, the analytics dashboard [1100] may be a presented to the user in a format separate from a webpage (i.e., similar to the display in FIG. 10), or the analytics dashboard [1100] may be accessible via a web interface. In some implementations which include displays as shown in FIG. 11, the labels on the types of metadata being tracked (team status, geographic markers, and promotion compliance in the diagram of FIG. 11) could be hyperlinked directly to a dedicated interface (as shown in FIG. 9d, for example), so that when the user clicks on a link they can automatically be logged into the custom web site and redirected to a page showing information associated with the data displayed on the analytics dashboard.

The analytics dashboard [1100] may present any information relevant to a user of the system in any suitable format. In the illustrated embodiment, the analytics dashboard comprises a first, second, and third window [1102], [1104], and [1106]. Additional window [1108] may be customized to provide other information to the user. Each window [1102], [1104], and [1106] may be an active link, such that by clicking on the window, the user may access the data supporting the information provided by the window. In the non-limiting embodiment, the first window [1102] is displaying a map [1110] comprising compliance markers [1112]. These compliance markers [1112] may appear on the map [1110] in real time (or substantially real time), as compliance information is received by the system. Accordingly, a person viewing the first window [1102] can receive visual geographical feedback in real-time. While a state map is shown merely for illustration purposes, it is to be appreciated that any map could be displayed in the first window [1102], such as a municipal map, a campus map, a building map, and so forth. The second window [1104] displays graphs associated with four teams. In the illustrated embodiment, the graphs indicate the number of total media elements have been uploaded by each team. These graphs provide an indication of each team's relative productivity. As is to be appreciated, any other team metric could be used for analytic purposes. The analytics presented in the illustrated embodiment are merely to illustrate one non-limiting embodiment. The third window [1106] provides a real-time chart associated with a particular promotion (PROMO1). The real-time chart may be used to visually indicate the level of compliance as a function of time. In some embodiments, an icon [1114] may be selected by the user to access a control panel to customize the analytics dashboard. Through the control panel, the user may determine which analytics they wish to view, the placement of the windows, and so forth.

As a further illustration the following disclosure sets forth various concrete examples of how various aspects of the inventor's technology can be used. First, consider the following example of the use of tagging functionality. Initially, a company administrator could set the tags to be used for identifying and/or describing media elements captured on behalf of his or her company. This process could include identifying a name for a tag, potential values for a tag, and a type associated with that tag. To support this tag set up, there could be a company-specific portion of a gateway which could include forms configured to allow the administrator (who could be an employee of the business which was defining the tags) to add, edit and/or remove tags, and which would store the resulting tags in the database. Alternatively, the company administrator could send a message to an entity maintaining the database and request that that entity make the appropriate changes to reflect the new tags. Examples of tag definitions which could be created during tag set up are set forth below in table 1:

TABLE 1
Example Tag Definitions

| Name | Type | Values | Required |
|---|---|---|---|
| Size | Select | Small, Medium, | Yes |
| | | Large | |
| Color | Text | | No |
| On Sale | Checkbox | | Yes |

While three tags are shown in Table 1, the present disclosure is not limited to any particular tag names or tag definition schema, nor is it limited to any particular number of tags. Instead, any suitable number of tags may be defined by a user and stored by the system. For example, in some embodiments, a tag hierarchy represented in table 2 may be used:

TABLE 2
Example Tag Hierarchy

| Team | Tag Category | Tag Value |
|---|---|---|
| TEAM 1 | Question 1 | Answer 1 |
| | | Answer 2 |
| | Question 2 | Answer 1 |
| | | Answer 2 |
| | | Answer 3 |
| | Question 3 | Answer 1 |
| | | Answer 2 |
| TEAM 2 | Question 4 | Answer 1 |
| | | Answer 2 |
| | Question 5 | Answer 1 |
| | | Answer 2 |
| | Question 6 | Answer 1 |
| | | Answer 2 |
| | Question 7 | Answer 1 |
| | | Answer 1 |

It is noted that the tag hierarchy may differ, or be customizable, for various implementations and applications. As such, Table 2 is merely to provide one example hierarchy and is not intended to be limiting. Instead of using “teams”, for example, a tag hierarchy may include other levels, such as brands, products, SKUs, companies, divisions, territories, and so forth. Furthermore, the tag hierarchy may be relatively simply or it may be relatively complex with multiple hierarchical layers. In some embodiments, such as the tag hierarchy shown in Table 2, the tag category may define a question, such as “is the section set?”, “is the product damaged?”, “what type of roadside repair is needed?”, and so forth. Potential answers may be stored in the tag hierarchy as tag values. Potential answers could be, for example, “Yes”, “No”, “spoiled”, “flat tire”, and so forth. When a user of the system is seeking to upload a media element via their mobile device, the tag hierarchy may determine how to tag the particular media element. The user may first be presented with a question that is based on their team, or based on other factors, such as territory, division, and so forth. They may then enter an answer the question with one of the answers provided (such as from a drop down menu). Once the information has been gathered from the user, the information can then be linked to the media element and uploaded to the central server for processing as described herein. Additionally, the real time communication aspects of the system could be used to improve the quality of media elements that are eventually uploaded to the database [504]. For example, in order to obtain optimal data, a representative using a mobile application could be given instructions or authorization to offer consumers special discounts or other incentives for allowing their reactions to in-store sample distributions or other promotions to be recorded. As a second example, because the mobile application could be implemented with built in functionality to ensure that captured media can be usefully retrieved and analyzed (e.g., requiring pre-specified tags to be selected for a picture before a media element can be captured), it is possible that lower skilled contractors could be used to actually capture media elements, rather than giving that responsibility to a company's sales representatives. These contractors could be employed by a business which specializes in using methods such as described (e.g., the same business which maintains the gateway and implements the mobile application), or could be independent contractors, such as might be paid using a payment utility integrated directly into the mobile application. Similarly, the existence of an easily accessible and usable database of media elements could allow for novel compensation schemes, such as making bonus payments to individuals who take media elements rated as highly useful, to individuals who take images which are heavily commented or analyzed, or based on some other metric.

It is also possible that the use of a real time infrastructure such as disclosed, as well as an easily accessible database of media elements and company specific web sites could be used to create a social media style environment for reviewing and interacting with the uploaded media elements [504]. For example, instead of (or in addition to) allowing comments on individual media elements, some implementations could allow all individuals who are examining a particular media element to see each other's input in real time (chat room implementation). Similarly, the system could identify individuals with similar patterns of media element examination (e.g., who look at the same types of media elements in a given period) and foster connections between those individuals (contact finder implementation). Other types of features common to social media could also be implemented, such as allowing rating of images with appropriate symbols (e.g., one to five stars, thumbs up/thumbs down). Users could then sort images with highest ratings and exchange ideas about them. There could also be profiles of users in the system, showing information such as their biographies, work histories, areas of expertise, interests and their photos, which could be linked to media elements they upload or comments they post so that other users could see who they are collaborating with. There could also be a live ticker showing recent comments and/or uploads throughout the day in a business' custom web portal. Similarly, some implementations might include a topics wall where a company could create a custom topic for employees to discuss and exchange ideas and knowledge on a specific subject.

In some embodiments, virtual room environments are provided as a platform for the exchange of information and real-time communication between multiple users based on tagged media elements. The virtual rooms described herein can allow for a variety of processing and analytic functionally through a social media interface. For example, a virtual room could be used for, without limitation, reporting, scheduling, centralized communication, and operations management. In some embodiments, a virtual room may serve as the centralized communications hub for a particular group of users (such as a sales team, for example). Some users may access the virtual room via a mobile device, while other user may access the same virtual room via a web interface on a desktop computer, for example. As is to be appreciated, the scope of the participants in a virtual room may vary. For example, in some embodiments, the members of virtual room may span multiple cities, states or even countries. On the other hand, other virtual rooms may only have members from a single location of a retail establishment. In one embodiment, members of a merchandising team for a grocery store use a virtual room as a centralized communication hub. In any event, as described in more detail below, the content displayed in the virtual room and the operational functionality of the virtual room may be largely driven by the tagging systems and methods described herein.

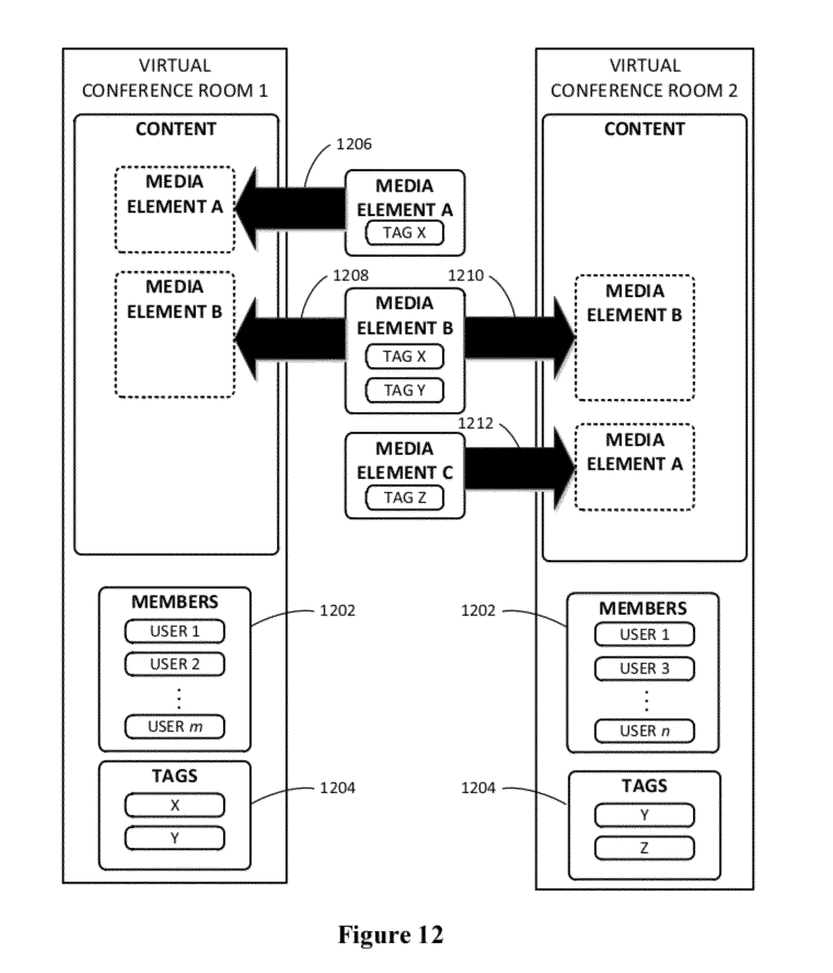

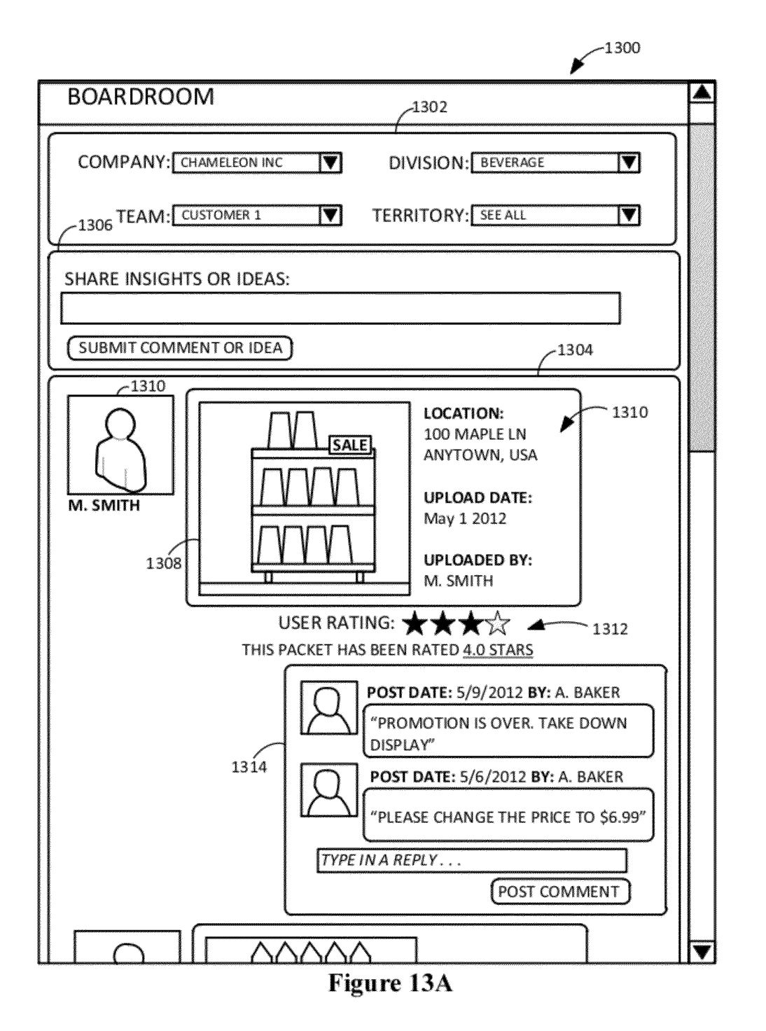

Referring now to FIG. 12, virtual room environments are shown in accordance with one non-limiting embodiment. In the illustrated embodiment, virtual conference room 1 and virtual conference room 2 are accessible to users who are denoted as members. The users may access the virtual conference room via any suitable technique, such as via a web interface or via an application on a mobile device or via a web interface or application on a desktop or laptop computer, for example. Access may to the various virtual conference rooms may be controlled via a member controller [1202]. In some embodiments, a system administrator has permission to access the member controller [1202]. As illustrated, USER 1 is a member of virtual conference room 1 and virtual conference room 2, USER 2 is a member of virtual conference room 1, and USER 3 is a member of virtual conference room 2. As is to be appreciated, the number of members of each conference room may be any suitable number, denote by USER m and USER n. In some embodiments, the virtual conference rooms may be grouped according to product, territory, company, division, or any other suitable grouping to provide a social media environment for its members.

At least some of the content that is displayed and maintained in the various conference rooms may be derived from the tagging infrastructure described herein. For example, a tag controller [1204] associated with each virtual conference room may be used to customize the content displayed in the various virtual conference rooms. In some embodiments, a system administrator has permission to access the tag controller [1204]. In the illustrated embodiment, media elements tagged with “X” and “Y” are displayed in virtual conference room 1, while media elements tagged with “Y” and “Z” are displayed in virtual conference room 2. It is noted that media elements tagged with “Y” will be presented in both conference rooms. Such processing may be desirable if the media content is of interest to more than one group of people. For example, virtual conference room 1 may be associated with a particular product, while virtual conference room 2 may be associated with a particular territory. Thus, the content of virtual conference room 1 may include media elements for a particular product that have been gathered across multiple territories. The content of virtual conference room 2, on the other hand, may be media elements associated with a wide variety of products from a single territory.

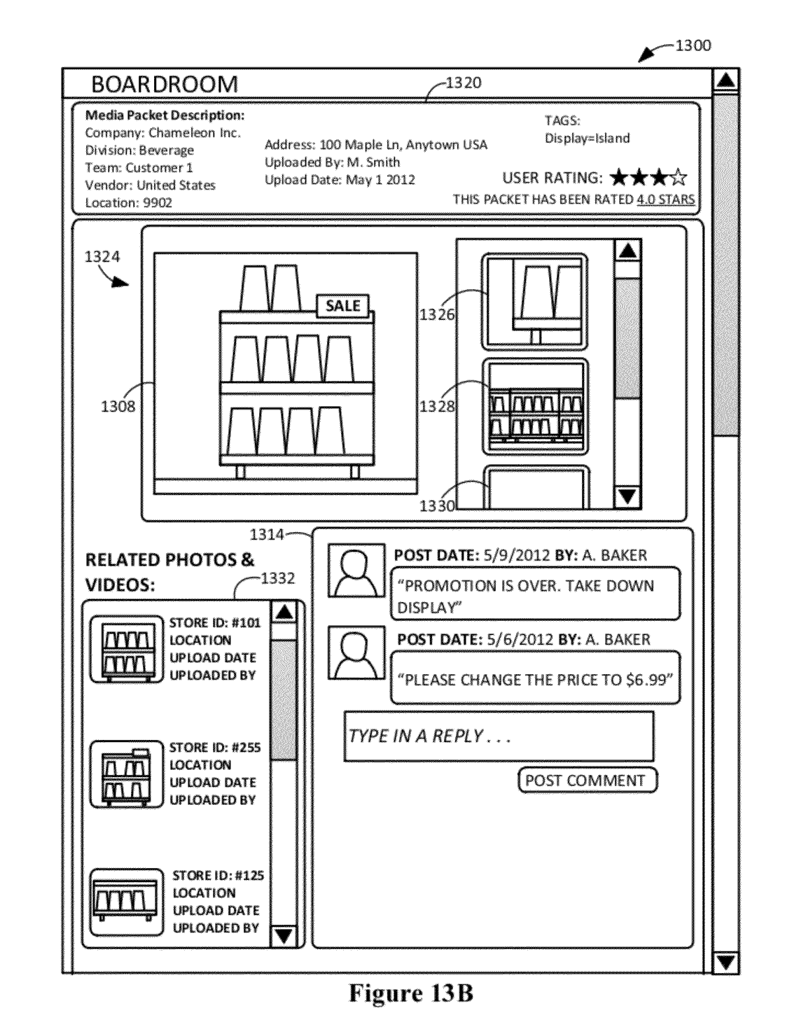

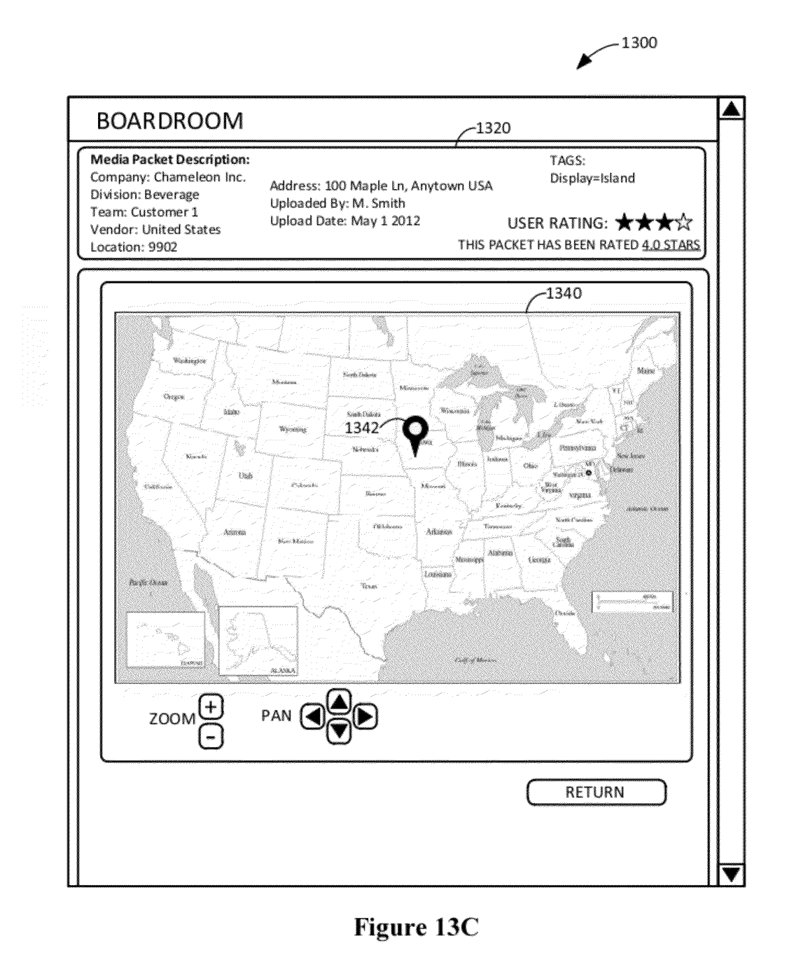

Still referring to FIG. 12, an example routing of media elements A, B, and C based on their associated tags is shown. Media element A is tagged with “X”. As is to be appreciated, the tag “X” may be associated with Media Element A in accordance with the systems and methods described herein. As denoted by the tag controller [1204] for virtual conference room 1, media elements with tag “X” are to be displayed to virtual conference room 1. Accordingly, the system routes media element A (or at least a visual representation of media element A) to virtual conference room 1, as schematically represented by routing arrow [1206]. USER 1, USER 2 . . . USER m may then view, comment, and access information regarding media element A (as discussed in more detail below with regard to FIGS. 13A-C). In some embodiments, the content in the various virtual conference rooms can be updated in real-time as media elements are received and processed by the system.

Media element B is tagged with “X” and “Y”. As denoted by the tag controller [1204] for virtual conference room 1, media elements with tag “X” are to be routed to virtual conference room 1. Accordingly, the system routes media element B to virtual conference room 1, as schematically represented by routing arrow [1208]. As denoted by the tag controller [1204] for virtual conference room 2, media elements with tag “Y” are to be routed to virtual conference room 2. Accordingly, the system also routes media element B to virtual conference room 2, as schematically represented by routing arrow [1210].

Media element C is tagged with “Z”, in accordance with the systems and methods described herein. As denoted by the tag controller [1204] for virtual conference room 2, media elements with tag “Z” are to be routed to virtual conference room 2. Accordingly, the system routes media element C to virtual conference room 2, as schematically represented by routing arrow [1212].

In addition to providing a social media infrastructrure with real time communication capability, the virtual room environment can also allow for a wide variety of analytics and processing to be performed on virtual room content. For example, in accordance with the systems and methods described herein, a variety reports may be generated that are based on the tag values of the media elements presented in the virtual room. The reports may provide, for example, compliance statistics, promotion status, quality metrics, team productivity, and so forth.

FIGS. 13A-13D show an example embodiment of a user interface [1300] for a virtual room. The user interface [1300] can generally be a social media platform that can fascilate, for example, online sharing, real time communications, and analytics virtual room environment. The user interface [1300] may be displayed on any networked device such as mobile device [501] or computers [505][506] (FIG. 5) to provide real time communication to members of the virtual room. For example, the user interface [1300] may be presented or otherwise hosted by an application server, a web server, or any other suitable technology. It is to be appreciated, that the present disclosure is not limited to the arrangement and content of user interface [1300] illustrated in FIGS. 13A-13D. Further, while the user interface [1300] is referred to as a “boardroom,” it is to be appreciated that a “boardroom” is merely one illustrative embodiment and is not intended to be limiting.

Referring first to FIG. 13A, a user may select which boardroom to view using a boardroom controller [1302]. In the illustrated embodiment, the boardroom controller [1302] comprise various drop-down menus that allow a user to select various parameters, such as company name, team name, division, territory, and so forth. In various embodiments, based on the user's credentials, the access to various boardrooms may be limited or otherwise pre-defined.

As shown in FIG. 13A, content that has been routed to the boardroom for “Chameleon Inc”, “Customer 1”, “Beverage” division is displayed in content field [1304]. In the illustrated embodiment, the user may post additional information to the boardroom using input field [1306]. As described above with regard to FIG. 12, the content associated with any particular boardroom may be regulated by the tags associated with media elements and the tags associated with the boardroom. If the user were to change any of the drop down menus in the boardroom controller [1302], the content of the boardroom displayed in the content field [1304] could update accordingly.

The content field [1304] may be structured and organized in any suitable arraignment. As discussed above, the various tags associated with a media element [1308] drives the media element [1308] to one or more board rooms. In the illustrated embodiment, a media element [1308] is graphically displayed proximate to the user [1310] that gathered the media element. In addition to visually displaying the media element [1308], descriptors [1310] may be presented to members of the boardroom. The descriptors [1310] may be gleaned from the tags associated with the media element [1308]. Various descriptors [1310] may be hyperlinked such that if a user clicks on a descriptor, additional information (i.e., analytics) is provided to the user. A rating field [1312] may display a rating associated with the media element [1308], as determined by the input from the users of the boardroom. The content field [1304] may also have a comment field [1314] providing a communication tool for the users.

The media element [1308] displayed in the content field [1304] may also be an active link, such that when a user clicks (or otherwise selects) the media element, a supplemental page is displayed (FIG. 13B). FIG. 13B illustrates and example of the user interface [1300] after the user has selected a particular media element. The user interface [1300] displays information to the user which may be gleaned from tags, metadata, and/or other data. A media packet description field [1320] may display a variety of information. The information may comprise hyperlinks so that a user can actively select one of the information elements to access even more information. For example, if I user were to click on the “Display=Island” tag, media elements having the same tag could be displayed. In some embodiment, a media packet associated with the media element [1308] may also be displayed in a media packet field [1324]. The media packet field [1324] may present a collection of media elements (photos, videos, and so forth) which are associated with one another. The association may be based on the tags associated with the various media elements. As illustrated, the media packet field [1324] displays the media element [1308] along with media elements [1326][1328][1330]. The comment field [1314] may be displayed proximate to the media packet field [1324]. In some embodiments, a related photos and video field [1332] may also be displayed on the interface. The content included in the related photos and video field [1332] may be determined by tags.

As mentioned above, the media packet description field [1320] may comprise hyperlinks so that a user can actively select one of the information elements to access even more information. FIG. 13C shows an example of the interface [1300] after the user has clicked on the address field in the media packet description field [1320] (FIG. 13B) in accordance with one non-limiting embodiment. A map [1340] may be presented to the user. In the illustrated embodiment, a marker [1342] is used to represent a geographical location of the media packet. For example, the marker [1342] may show the location of a grocery store in which the media elements associated with the media packet were gathered. In other embodiments, the market [1342] may represent where a road-side repair was performed, the location of a franchise, the location of a repair by a public works employee, and so forth. In some embodiments, visual reporting may be provided via the map [1340]. For example, using tag values associated with media elements routed to the content field [1304] (FIG. 13A), reports may be executed to place visual markers on the map [1340] indicating a variety of events. For example, markers could be generated to indicate the construction of a promotional display, the existence of a damaged product, or any other event that is trackable based on the tagging process described herein.

It should be understood that, while the disclosure above focused on using the inventor's technology to address needs of manufacturers, wholesalers or retailers to obtain information about the presentation of consumer products, consumer goods or consumer packaged goods in stores, the disclosed technology is not limited to use in that context. For example, retailers could use technology such as set forth herein to collect and manage information related to in-store signage, compliance with display requirements, or the general conditions or layout of their individual locations. Similarly, the disclosed technology could be beneficially applied in other fields, such as restaurants, where it could be used to monitor the condition of food preparation and serving areas (as well as other information, like signage information which might be appropriate in a given case). Also, it should be understood that the technology set forth herein could be used in ways which account for overlap between categories. For example, retailers such as grocery stores could monitor their private label products in the same way manufacturers could monitor their branded products, in addition to monitoring data which might be specific to a retail setting.

The technology could also be applied in other settings where it is desirable to monitor or gather data about remote locations. As an example of this, consider the commercial roadside assistance industry. An entity in that industry may have a need to account for, and manage, a large number of field repairs (e.g., repairs done on the roadside, or at garages close to where a breakdown actually occurs). In that industry, rather than tagging specific products, the system could be used with tags identifying data such as particular repair type, type of chassis repaired, vendor who performs repair, and operator of vehicle repaired. Similarly, rather than focusing on promotions and alerts as described (though such promotions and alerts could be included as well), there could be special categories for things like work order number. Compliance could then be tracked based on whether the work order was complete, time for completion, cost of completion, etc. Further, rather than (or in addition to), using location information to correlate media elements with sales representatives, the location information could be used to identify hot spots where more (or fewer) vendor relationships are needed, or to identify distances between where a vendor is located, where a repair occurs, and where the repair was requested (e.g., where a breakdown occurs).

As another example of how the technology could be applied, consider the case of the wind turbine industry. An entity in that industry may have a need, such as imposed by environmental laws and/or regulations, to track wind turbine bird and bat strikes and to record frequency, weather conditions, and specific location of strikes uploading tagged video and photo files directly to a centralized database. In that industry, rather than tagging specific products, the system could be used with tags to document specific bird and bat species, tabulating the total number of each species striking individual wind turbines. The system could also use tagged videos to capture large areas around wind turbines. Information would be summarized by wind turbine farm or region. The system would provide global maps to identify this information geographically possibly overlaying on bird and bat species habitats and populations. In this application, images and videos would be captured with a mobile device (e.g., smartphones) by a person inspecting areas beneath each wind turbine.

It is also possible that the technology disclosed herein could be implemented in the manufacturing industry to facilitate compliance with safety requirements. An entity in that industry may have to need to track safety compliance at their manufacturing or assembly plants. Rather than tagging specific products, in this case, the system could be used with tags to document any safety compliance requirements uploading tagged video and photo files directly to a centralized database for analysis. Priorities and Alert instructions on the mobile device (e.g., smartphones) could tell the user what specific safety compliance tasks/issues to capture with tagged video or photos. When a particular safety issue is corrected and in compliance, the user could capture with tagged video or photo then upload to centralized database to verify that compliance status. The system will track and provide compliance reports summarizing progress made for each safety issue. In this case, images and videos could be captured with a mobile device (e.g., smartphone) by inspectors.

The disclosed technology can also be used in the franchise industry. An entity in that industry may have a need to track franchise compliance issues for any franchise with multiple locations. Standardization is critical and required in the franchise industry. The system provides visual proof of compliance for the franchise industry. Rather than tagging specific products, the system could be used with tags to document pre and post construction, in-store layout and design, signage, promotional signage positioning, cleanliness, quality of product, vehicle and uniform compliance just to name a few examples. In this application, the system could be used to detail gaps and inconsistencies with franchise compliance, providing real-time reports and geographical maps showing where there are compliance issues. In this implementation, images and videos would likely be captured with a mobile device (e.g., smartphone) by franchise owners or managers.

The disclosed technology can also be used in public works, college/university, governmental, or municipality sectors. A governmental entity, such as a city's public works department, for example, may need to track maintenance, repairs, or other services that are performed around a city. Such trackable events may include, without limitation, pothole locations, pothole repairs, streetlight repairs, downed trees, road sign issues, standing water, storm damage, traffic issues, and so forth. A media element visually logging the event may be uploaded to a centralized database in accordance with the systems and methods described herein. The media element may depict the issue (such as fallen power lines, pot hole, or water main break, for example), or may depict a resolved issue (such as a repair of a pot hole, trimmed trees, or repaired sideway, for example). In any event, the location may be tagged with a geographic location by the user and tag with any other information related to the event. The geographic location could be provided using any suitable technique, such as a street address, cross streets, longitude/latitude, building name, park name, and so forth. Other tags associated with the media element may identify, for example, date of repair, name of company performing repair, quality of repair, or other tag category. Upon being uploaded, the location of the event may be indicated on an electronic map associated with the centralized database. For example, a geographic report interface may be presented with individual locations on a map marked with distinctive markers (such as a different shape, different size, or different color, for example) depending on the tag value for the tag category associated with media elements from those locations. It is to be appreciated that the system and methods described herein may be used in a variety of governmental sectors in which visual event reporting may be beneficial, such as county, city, state, and federal agencies. Additionally, other entities having maintenance responsibilities, such as golf course ground crews, college/university ground or maintenance crews, building management crews, and so forth may utilize the system and methods described herein for tracking various issues, events, and repairs.

In general, it will be apparent to one of ordinary skill in the art that at least some of the embodiments described herein may be implemented in many different embodiments of software, firmware, and/or hardware. The software and firmware code may be executed by a processor or any other similar computing device. The software code or specialized control hardware that may be used to implement embodiments is not limiting. For example, embodiments described herein may be implemented in computer software using any suitable computer software language type, using, for example, conventional or object-oriented techniques. Such software may be stored on any type of suitable computer-readable medium or media, such as, for example, a magnetic or optical storage medium. The operation and behavior of the embodiments may be described without specific reference to specific software code or specialized hardware components. The absence of such specific references is feasible, because it is clearly understood that artisans of ordinary skill would be able to design software and control hardware to implement the embodiments based on the present description with no more than reasonable effort and without undue experimentation.

Moreover, the processes associated with the present embodiments may be executed by programmable equipment, such as computers or computer systems and/or processors. Software that may cause programmable equipment to execute processes may be stored in any storage device, such as, for example, a computer system (nonvolatile) memory, an optical disk, magnetic tape, or magnetic disk. Furthermore, at least some of the processes may be programmed when the computer system is manufactured or stored on various types of computer-readable media.

It can also be appreciated that certain process aspects described herein may be performed using instructions stored on a computer-readable medium or media that direct a computer system to perform the process steps. A computer-readable medium may include, for example, memory devices such as diskettes, compact discs (CDs), digital versatile discs (DVDs), optical disk drives, or hard disk drives. A computer-readable medium may also include memory storage that is physical, virtual, permanent, temporary, semipermanent, and/or semitemporary.

In various embodiments disclosed herein, a single component may be replaced by multiple components and multiple components may be replaced by a single component to perform a given function or functions. Except where such substitution would not be operative, such substitution is within the intended scope of the embodiments. Any servers described herein, for example, may be replaced by a “server farm” or other grouping of networked servers (such as server blades) that are located and configured for cooperative functions. It can be appreciated that a server farm may serve to distribute workload between/among individual components of the farm and may expedite computing processes by harnessing the collective and cooperative power of multiple servers. Such server farms may employ load-balancing software that accomplishes tasks such as, for example, tracking demand for processing power from different machines, prioritizing and scheduling tasks based on network demand and/or providing backup contingency in the event of component failure or reduction in operability.

The computer systems may comprise one or more processors in communication with memory (e.g., RAM or ROM) via one or more data buses. The data buses may carry electrical signals between the processor(s) and the memory. The processor and the memory may comprise electrical circuits that conduct electrical current. Charge states of various components of the circuits, such as solid state transistors of the processor(s) and/or memory circuit(s), may change during operation of the circuits.

Other variations and modifications will be immediately apparent to those of ordinary skill in the art in light of this disclosure, as a result, the protection afforded by this document, or by any related document, should not be limited to the material explicitly disclosed herein, but instead should extend to the full extent of the claims (either in this document or any particular related document) when the terms in those claims are given their broadest reasonable interpretation as provided by a general purpose dictionary in light of any explicit definitions included in a related document, as well as the explicit definitions set forth below.

### EXPLICIT DEFINITIONS

When used in the claims, an “application” should be understood to refer to a program designed to perform a specific function.

When used in the claims “based on” should be understood to mean that something is determined at least in part by the thing that it is indicated as being “based on.” When something is completely determined by a thing, it will be described as being “based EXCLUSIVELY on” the thing.

When used in the claims, to “configure” something in the context of a computer or similar device should be understood to refer to providing the computer or other device with specific data (which may include instructions) which can be used in performing the specific acts the computer or other device is being “configured” to do. For example, installing Microsoft WORD on a computer “configures” that computer to function as a word processor, which it does using the instructions for Microsoft WORD in combination with other inputs, such as an operating system, and various peripherals (e.g., a keyboard, monitor, etc. . . . ).

When used in the claims, “consumer goods” should be understood to mean goods purchased that satisfy human wants through their direct consumption or use.

When used in the claims, “consumer packaged goods” should be understood to mean consumable goods such as food and beverages, footwear and apparel, tobacco, and cleaning products.

When used in the claims, “consumer products” should be understood to mean any tangible personal property for sale and that is used for personal, family, or household for non-business purposes.

When used in the claims, “data” should be understood to refer to information which is represented in a form which is capable of being processed, stored and/or transmitted.

When used in the claims, to “determine” something should be understood to refer to the act of generating, selecting or otherwise specifying something. For example, to obtain an output as the result of analysis would be an example of “determining” that output. As a second example, to choose a response from a list of possible responses would be a method of “determining” a response.

When used in the claims, a “media element” should be understood to refer to a data object, such as a file, which includes one or more images, and may also include other types of information, such as sound. Examples of “media elements” include pictures and videos.

When used in the claims, a statement that something is “merchandised” should be understood to refer to the thing “merchandised” being promoted (e.g., by point of purchase displays or signage).

When used in the claims, a “mobile device” should be understood to include a pocket-sized or handheld computing device, typically having a display screen with touch input and/or a miniature keyboard. Generally a “mobile device” will be sized appropriately to be held in a single handle. However, larger “mobile devices” such as notebooks, laptops, and netbooks are also possible.

When used in the claims, “priorities’ should be understood to refer to instructions or tasks to be completed.

When used in the claims, a statement that something happens in “substantially real time” should be understood to mean that the thing happens within close enough temporal proximity to its triggering event that the propagation delay between the triggering event and the event which happens in substantially real time does not prevent actions to be taken with respect to the triggering event. For example, if an in image is displayed on a screen in substantially real time after being captured, and it is possible to communicate a message to the person who captured the image in substantially real time, then additional information regarding the image can be captured, such as taking another image of the same subject at a different angle. Temporally, something which happens with a propagation delay of five minutes or less is generally something which happens in “substantially real time.”

1. A computer-implemented method, comprising:
receiving parameters for a virtual room, the virtual room displayable on a graphical interface, the virtual room comprising a media content field, wherein media elements displayed in the media content field of the virtual room are at least partially based on one or more tags associated with the media elements, and wherein the parameters define, at least in part, members of each of the virtual room and tag values associated with the virtual room;
transmitting a graphical representation of the virtual room to at least one graphical display device via an electronic communications network;
receiving a media element via the electronic communications network, the media element captured at a mobile device associated and uploaded with at least one tag having a value, wherein the value of the tag is defined by a member of the virtual room; and
responsive to receiving the media element, when the value of tag associated with the media element corresponds with the tag value associated with the virtual room, causing a graphical representation of the media element to be displayed in the media content field of the virtual room.

2. The computer-implemented method of claim 1, wherein the virtual room is one of a plurality of virtual rooms.

3. The computer-implemented method of claim 2, wherein responsive to receiving the media element, causing a graphical representation of the media element to be displayed in the media content field of one or more of the plurality of virtual rooms.

4. The computer-implemented method of claim 2, wherein the plurality of virtual rooms comprises a first virtual room and a second virtual room.

5. The computer-implemented method of claim 4, wherein a first member has access to view the first virtual room, a second member has access to view the second virtual room, and a third member has access to view the first virtual room and the second virtual room.

6. The computer-implemented method of claim 1, comprising:
causing the displaying a virtual room selection field; and
upon receiving a virtual room selection, causing the display of the contents of the selected virtual room.

7. The computer-implemented method of claim 6, comprising:
subsequent to causing the display of the contents of the selected virtual room, updating the contents of the selected virtual room in substantially real time when an additional media element is received.

8. The computer-implemented method of claim 1, wherein media element is graphically displayed in a graphical representation of a media packet, the media packet comprising a plurality of similarly tagged media elements.

9. The computer-implemented method of claim 1, comprising:
responsive to receiving a selection of the graphical representation of the media element, causing the display of tag values associated with the media element.

10. A system comprising a non-transitory computer readable medium having instructions stored thereon which when executed by a processor cause the processor to:
cause the display of a graphical representation of media elements in a virtual room on at least one graphical display device,
receive a media element uploaded by a remote mobile device, the media element uploaded with at least one tag having a tag value;
responsive to receiving the media element, cause a graphical representation of the media element to be displayed in the virtual room when the tag value of the tag corresponds with a tag value associated with the virtual room;
receive at least one text-based input associated with the graphical representation of the media element; and
responsive to receiving the at least one text-based comment, cause the display of a graphical representation of the text-based input proximate to the graphical representation of the media element on the at least one graphical display device in substantially real time.

11. The system of claim 10, wherein the non-transitory computer readable medium has instructions stored thereon which when executed by a processor cause the processor to:
cause the display of a graphical representation of a map; and
cause the display of a graphical marker placed on the map corresponding to a geographical location associated with the tag value of the media element.

12. The system of claim 10, wherein the non-transitory computer readable medium has instructions stored thereon which when executed by a processor cause the processor to:
cause the display of a graphical representation of a media element in a plurality of virtual rooms.

13. The system of claim 12, wherein the plurality of virtual rooms comprises a first virtual room and a second virtual room.

14. The system of claim 13, wherein the non-transitory computer readable medium has instructions stored thereon which when executed by a processor cause the processor to:
responsive to receiving the media element, cause a graphical representation of the media element to be displayed in the first virtual room when the value of tag associated with the media element corresponds with a tag value associated with the first virtual room.

15. A computer-implemented method, the method comprising:
receiving, from a first mobile device, a first set of tagged observation data;
storing the first set of tagged observation data in database;
providing a graphical display to a remote computing device, the graphical display graphically displaying information based on the first set of tagged observation data;
subsequent to providing the graphical display to the remote computer, receiving, from a second mobile device, a second set of tagged observation data;
responsive to receiving the second set of tagged observation data, updating the graphical display based on the second set of tagged observation data; and
providing the updated graphical display to the computing device.

16. The computer-implemented method of claim 15, wherein the graphical display is updated in substantially real time.

17. The computer-implemented method of claim 15, wherein the graphical display comprises an electronic link.

18. The computer-implemented method of claim 18, comprising:
upon receiving a selection of the electronic link, causing a webpage to be displayed on the remote computer.

19. The computer-implemented method of claim 18, wherein the graphical display comprises at least one of a chart and a map.

20. The computer-implemented method of claim 19, wherein the at least one of a chart and the map is updated in substantially real time.
